(19) United States
(12) Patent Application Publication
(10) Pub. No.: US 2026/0049205 A1
(43) Pub. Date: Feb. 19, 2026

(54) HIGH-HUMIDITY GAS AND VAPOR BARRIER ARTICLES

(71) Applicant: Georgia Tech Research Corporation, Atlanta, GA (US)

(72) Inventors: James Carson Meredith, III, Atlanta, GA (US); Natalie Stingelin, Atlanta, GA (US); Tanner John Hickman, Atlanta, GA (US)

(21) Appl. No.: 19/300,036

(22) Filed: Aug. 14, 2025

Related U.S. Application Data
(60) Provisional application No. 63/683,038, filed on Aug. 14, 2024.

(51) Int. Cl. C08L 5/00; C08J 3/24; C08J 5/18; C08K 5/092; C08L 1/28

(52) U.S. Cl. CPC C08L 5/00; C08J 3/246; C08J 5/18; C08K 5/092; C08L 1/286; C08L 5/08; C08J 2301/28; C08J 2305/00; C08L 2203/16; C08L 2312/00

(57) ABSTRACT

Articles are provided including a composition, wherein the composition includes a polyelectrolyte complex, wherein the polyelectrolyte complex is formed from a cellulose derivative and chitosan. Articles are also provided including cellulose or a cellulose derivative and citric acid (CA), wherein the cellulose or cellulose derivative is crosslinked with the citric acid; and wherein the citric acid is present in an amount of about 25% by weight based on a total weight of the composition.

### CROSS-REFERENCE TO RELATED APPLICATIONS

This application claims the benefit of priority to U.S. Provisional Patent Application No. 63/683,038 filed Aug. 14, 2024, the disclosure of which is incorporated herein by reference in its entirety.

### BACKGROUND

Polysaccharides are attractive starting materials to design renewable alternatives to petroleum-based plastics for high-volume applications such as packaging. However, their moisture sensitivity, a direct result of their hydrophilic side groups, makes them susceptible to plasticization in high moisture environments, leading to changes in their physical properties and impeding their utilization. Approaches to limit their moisture sensitivity, such as chemical crosslinking or functionalization, are complicated by the highly variable side group chemistry of different polysaccharides.

There is a clear need to develop polysaccharide-based films with higher moisture resistance to increase their uptake as alternatives to petroleum-based plastics in applications such as packaging. This disclosure addresses this as well as other needs.

### SUMMARY

The present disclosure provides articles and processes for manufacturing said articles. The articles described herein are formed from biodegradable materials while improving properties, such as water vapor transmission rate (WVTR), of said biodegradable materials to approach or match such properties of currently used nonbiodegradable materials.

In one aspect, an article is provided including a composition. In some aspects, the composition includes a polyelectrolyte complex, wherein the polyelectrolyte complex is formed from a cellulose derivative and chitosan. In some aspects, the article is a film, a coating, a tape, a foam, a bulk material, or a packaging material. In some aspects, the article is a film.

In some aspects, the cellulose derivative includes carboxymethyl cellulose (CMC). In some aspects, carboxymethyl cellulose has a degree of substitution of about 1.2.

In some aspects, chitosan includes from about 50% to about 75% by weight based on a total weight of the composition. In some aspects, chitosan has a degree of ionization from about 20% to about 40%. In some aspects, the composition is further crosslinked with a crosslinker. In some aspects, the crosslinker includes citric acid (CA). In some aspects, the crosslinker includes citric acid in an amount of about 25% by weight based on a total weight of the composition.

In some aspects, at a temperature of about 23° C. and a relative humidity from about 50% to about 75%, the composition has a thickness-adjusted water vapor transmission rate (WVTR) from about 0.014 to about 4 g-mm/m²-day. In some aspects, the composition has a residual water content (RWC) from about 4% to about 6%.

In another aspect, a process of manufacturing a film is provided. In some aspects, the process includes preparing a first solution including the cellulose derivative and a volatile acid, wherein the volatile acid is present in the first solution in an amount to adjust the pH of the first solution from about 1 to about 2. In some aspects, the process includes preparing a second solution including the chitosan and the volatile acid, wherein the volatile acid is present in the second solution in an amount to adjust the pH of the second solution from about 1 to about 2. In some aspects, the process includes combining the first solution and the second solution to form a mixture. In some aspects, the process includes casting and drying the mixture to form the film. In some aspects, the volatile acid includes formic acid. In some aspects, the first solution, the second solution, or both, further include a crosslinker.

In another aspect, an article is provided including a composition. In some aspects, the composition includes cellulose or a cellulose derivative and citric acid (CA). In some aspects, the cellulose or cellulose derivative is crosslinked with the citric acid. In some aspects, the citric acid is present in an amount of about 25% by weight based on a total weight of the composition. In some aspects, the article is a film, a coating, a tape, a foam, a bulk material, or a packaging material. In some aspects, the article is a film. In some aspects, the cellulose derivative includes carboxymethyl cellulose (CMC). In some aspects, at a temperature of about 23° C. and a relative humidity up to about 65%, the composition has a thickness-adjusted water vapor transmission rate (WVTR) of less than about 0.02 g-mm/m²-day.

The details of one or more aspects of the disclosure are set forth in the accompanying drawings and the description below. Other features, objects, and advantages of the disclosure will be apparent from the description, the drawings, and the claims.

### DESCRIPTION OF DRAWINGS

FIGS. 1A-1E depict and provide data demonstrating that films dried from formic acid solution are more homogeneous and transparent than films dried from HCl solution as described in the examples. (FIG. 1A) Pictures of CMC/CH films with 50 wt % CH mixed in HCl solution with pH=1.6 and adjusted to different pH by adding NaOH. (FIG. 1B) Normalized FTIR spectra of different sides, denoted “top” and “bottom”, of CMC/CH films with 50 wt % CH dried from HCl solution with different pH before (left panel) and after (right panel) washing with DI water. (FIG. 1C) CMC, CH, and CMC/CH solutions with pH 1.8 adjusted using formic acid after storage at room temperature for 5 months. (FIG. 1D) CMC, CH, and CMC/CH films dried from solutions with pH 1.8 adjusted using formic acid. (FIG. 1E) CMC, CH, and CMC/CH films with 25 wt % CA dried from solutions with pH 1.8 adjusted using formic acid.

FIG. 2 depicts and provides data demonstrating that CMC/CH films with 75 wt % CH have the greatest moisture resistance and lowest water vapor transmission rate (WVTR). (Panel A) Water vapor transmission rate (WVTR) of CMC/CH blend films after heat treatment at 50% RH. (Panel B) Contact angle (θcontact) of CMC/CH blend films after heat treatment. (Panel C) Residual water content (RWC) of CMC/CH blend films after heat treatment. (Panel D) Molar ratio of ammonium (NH₃⁺) to carboxylate (COO⁻) groups for CMC/CH blend films with 100% ionized CMC (1.2 COO⁻ per monomer) and different CH ionization (a_{cu}).

FIGS. 3A-3B depict and provide data demonstrating that CMC/CH films comprise fully ionized CMC and partially ionized CH when dried from formic acid solution as described in the examples. (FIG. 3A) FTIR spectra, normalized from 0 to 1, of CMC, CH, and CMC/CH blend films dried from their parent solutions and from solutions with pH<2 using HCl or formic acid (FA) before (left) and after (right) heat treatment. (FIG. 3B) FTIR spectra, normalized from 0 to 1, of CMC/CH films with different wt % CH dried from formic acid (FA) solution with pH=1.8 (black lines) and from HCl solution with pH=1.9 (grey lines).

FIG. 4 depicts and provides data demonstrating that the degree of hydration per intrinsic ion pair in CMC/CH films decreases dramatically with increasing CH content as described in the examples. (Panel A) Residual water content (RWC) of CMC/CH films after heat treatment. (Panel B) Number of intrinsic ion pairs in CMC/CH films for different degrees of ionization of CH (CMC assumed to be 100% ionized). (Panel C) Molar ratio of water to intrinsic ion pairs in CMC/CH films for different degrees of ionization of CH (CMC assumed to be 100% ionized).

FIGS. 5A-5C depict and provide data demonstrating that citric acid crosslinks CMC/CH and leads to lower water vapor transmission rates (WVTR) at high humidity as described in the examples. (FIG. 5A) Water vapor transmission rate (WVTR) of CMC/CH blend films crosslinked by CA compared to neat CMC crosslinked by CA at 80% RH. (FIG. 5B) Representative stress-strain curves of heat-treated CMC/CH blend films (dashed lines) compared to heat-treated CMC/CH blend films crosslinked by CA (solid lines) with different wt % CH. Inset shows the low strain region where crosslinked films fracture. (FIG. 5C) FTIR spectra, normalized from 0 to 1, of CMC/CH blend films crosslinked by CA (solid lines) compared to CMC/CH blend films (dashed lines) with different wt % CH. The middle panel also shows the spectra of CMC/CH/CA with 50 wt % CH dried from HCl solution with pH<2 (grey line).

FIGS. 6A-6B depict that: (FIG. 6A) Equal mass mixtures of CMC and CH at different pH and NaCl concentrations. Inset shows salt crystals in a film dried via drop casting at room temperature from a solution with a pH of 2 and NaCl concentration of 0.2 M. (FIG. 6B) CMC/CH films with varying CH content dried from pH=1.6 and 0 M NaCl.

FIG. 7 provides a simplified illustration of the compositional changes of CMC/CH films throughout the film thickness as described in the examples.

FIGS. 8A-8D depict and provide data demonstrating that the bulk properties of films prepared from blends of oppositely charged polyelectrolytes are strongly dependent on the processing method as described in the examples. (FIG. 8A) Water vapor transmission rate (WVTR) at 50% relative humidity (RH) (bars) and soluble fraction in deionized water (line with markers) of CMC films dried from solution in deionized water with the native pH of sodium carboxymethyl cellulose (approximately 7) and pH 1.8, adjusted using formic acid. Both films were dried at 120° C. for 2 hours to remove residual solvent. (FIG. 8B) Density of CMC/CH films with 50 wt % CH mixed in HCl solution with pH=1.6 and adjusted to different pH by adding NaOH. (FIG. 8C) WVTR at 80% RH of a CMC/CH blend film with 50 wt % CH mixed in HCl solution with pH=1.6 and adjusted to pH=2 by adding NaOH before (grey) and after (white) washing the film with an excess of deionized water. All WVTR was measured at 23° C. (FIG. 8D) Atomic force microscopy (AFM) height images of CMC/CH blend films with 50 wt % CH dried from solution in deionized water with different pH adjusted using HCl before (top images) and after (bottom images) washing the films with an excess of deionized water. Note that the rightmost images have a scan size of 8 microns while all other images have a scan size of 2 microns.

FIG. 9 provides data regarding the zeta potential of CMC and CH solutions at different pH (left panel) and of CMC/CH solutions at pH=1.8 with different CH content (right panel) as described in the examples. The weight percent CH (right panel) refers to the CH content with respect to total dissolved solids. Grey markers indicate the zeta potential of neat CH solutions at pH=1.8 with concentrations equal to that of CH in the equivalent CMC/CH solution.

FIG. 10 provides data regarding the water vapor transmission rate (WVTR) of a CMC/CH blend film (50 wt % CH) compared to the equivalent CMC/CH blend film crosslinked by CA (50 wt % CH, 25 wt % CA) and poly(ethylene terephthalate) (PET) at different relative humidities as described in the examples.

FIG. 11 provides data regarding the upper tensile strength (UTS), strain at break (SAB), and Young's modulus (YM) of CMC/CH blend films before (left) and after (middle) heat treatment, and of CMC/CH/CA films after heat treatment (right) as described in the examples. The box, black line, and whiskers represent the middle quartile (25-75%), mean, and minimum/maximum of the data, respectively. Individual data points are shown as circular markers.

FIG. 12 provides data regarding the percent mass (top) and derivative mass (bottom) measured at 20° C./min of CMC/CH blend films before (left) and after (middle) heat treatment, and of heat-treated CMC/CH blend films crosslinked by CA (right) as described in the examples.

FIG. 13 provides data regarding the residual water content (RWC) of CMC/CH blend films (grey markers) and CMC/CH blend films crosslinked by CA (black markers) with different wt % CH as described in the examples.

FIGS. 14A-14B provide DSC thermograms measured at 20° C./min of citric acid monohydrate and of (FIG. 14A) CMC with different wt % CA, and of (FIG. 14B) CMC/CH films (dashed lines) and CMC/CH/CA films (right, solid lines) as described in the examples.

FIGS. 15A-15D depict and provide data regarding carboxymethyl cellulose (CMC) crosslinked by citric acid (CA) with very low water vapor transmission rate (WVTR) as described in the examples. (FIG. 15A) Structure of CMC crosslinked by CA with full (left) and partial (right) crosslinks. (FIG. 15B) FTIR spectra of CMC/CA films with 0, 10, 25, and 50 wt % CA before (grey) and after (black) deprotonation of free acid groups via NaOH treatment. Note that neat CMC does not feature the characteristic 1718 cm⁻¹ ester vibration, and therefore does not form crosslinks with itself. All spectra are normalized by their maximum absorbance. (FIG. 15C) WVTR of CMC/CA films and PET at 23° C. and 50% RH (left), and at different RH (right). Error bars represent the standard deviation of at least two measurements. (FIG. 15D) Summary of WVTR for various films and testing conditions showing that the lowest WVTR of CMC with 25% CA is comparable to commercial water barrier plastics.

FIG. 16 provides photographs of CMC/CA films dried in polystyrene (PS) and polytetrafluoroethylene (PTFE) dishes as described in the examples.

FIGS. 17A-17B provide data demonstrating that Accumulation of unreacted and partially reacted citric acid (CA) above the maximum crosslink density leads to increased residual water content (RWC) and hydration of CA as described in the examples. (FIG. 17A) Soluble fraction (top panel) and residual water content (bottom panel), for CMC/CA films before (grey markers) and after (black markers) heat treatment. Both the soluble fraction and residual water content show a non-monotonic behavior with a minimum at 25 wt % CA, the composition corresponding to the maximum crosslink density. Error bars represent the standard deviation of at least three measurements. (FIG. 17B) Tensile properties of CMC/CA films before heat treatment (top panel), after heat treatment (middle panel, and after heat treatment and aging at 75% RH for seven days (bottom panel). The data shown here represents a single measurement. Insets highlight the data in the low strain regime.

FIG. 18 provides data regarding the tensile properties of CMC/CA films as described in the examples containing (panel A) 0 wt % CA, (panel B) 10 wt % CA, (panel C) 25 wt % CA, and (panel D) 50 wt % CA before and after heat treatment, and at 75% RH as designated therein.

### DETAILED DESCRIPTION

The following description of the disclosure is provided as an enabling teaching of the disclosure in its best, currently known aspects. Many modifications and other aspects disclosed herein will come to mind to one skilled in the art to which the disclosed compositions and methods pertain, benefiting from the teachings presented in the descriptions herein and the associated drawings. Therefore, it is understood that the disclosures are not limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As is apparent to those of skill in the art upon reading this disclosure, each of the individual aspects described and illustrated herein has discrete components and features that may be readily separated from or combined with the features of any of the other several aspects without departing from the scope or spirit of the present disclosure.

Any recited method can be carried out in the order of events recited or any other order that is logically possible. Unless otherwise expressly stated, it is in no way intended that any method or aspect set forth herein be construed as requiring that its steps be performed in a specific order. Accordingly, where a method claim does not explicitly state in the claims or descriptions that the steps are to be limited to a particular order, it is in no way intended that an order be inferred in any respect. This holds for any possible non-express basis for interpretation, including logic concerning the arrangement of steps or operational flow, meaning derived from grammatical organization or punctuation, or the number or type of aspects described in the specification.

All publications mentioned herein are incorporated by reference to disclose and describe the methods or materials in connection with which the publications are cited. The publications discussed herein are provided solely for their disclosure before the filing date of the present application. Further, the dates of publication provided herein can be different from the actual publication dates, which can require independent confirmation.

It is also to be understood that the terminology herein describes particular aspects only and is not intended to be limiting. Unless defined otherwise, all technical and scientific terms herein have the same meaning as commonly understood by one of ordinary skill in the art to which the disclosed compositions and methods belong. It can be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Before describing the various aspects of the present disclosure, the following definitions are provided and should be used unless otherwise indicated. Additional terms may be defined elsewhere in the present disclosure.

### Definitions

As used herein, “comprising” is interpreted as specifying the presence of the stated features, integers, steps, or components, but does not preclude the presence or addition of one or more features, integers, steps, components, or groups thereof. Moreover, each of the terms “by,” “comprising,” “comprises,” “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, “consisting essentially of” is intended to include examples encompassed by the term “consisting of.”

As used in the specification and the appended claims, the singular forms “a,” “an,” and “the” include plural referents unless the context dictates otherwise.

Ratios, concentrations, amounts, and other numerical data can be expressed herein in a range format. Further, the endpoints of each of the ranges are significant both in relation to the other endpoint and independently of the other endpoint. There are many values disclosed herein, and each value is also disclosed as “about” that particular value in addition to the value itself. For example, if the value “10” is disclosed, then “about 10” is also disclosed. Ranges can be expressed herein as from “about” one particular value and to “about” another particular value. Similarly, when values are expressed as approximations, using the antecedent “about,” the particular value forms a further aspect. For example, if the value “about 10” is disclosed, then “10” is also disclosed.

When a range is expressed, a further aspect includes from the one particular value and to the other particular value. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x,’ ‘about y,’ and ‘about z’ as well as the ranges of ‘less than x,’ ‘less than y.’ and ‘less than z.’ Likewise, the phrase ‘about x, y, z, or greater’ should be interpreted to include the specific ranges of ‘about x,’ ‘about y,’ and ‘about z’ as well as the ranges of ‘greater than x,’ greater than y,′ and ‘greater than z.’ In addition, the phrase “about ‘x’ to ‘y’,” where ‘x’ and ‘y’ are numerical values, includes “about ‘x’ to about ‘y’.”

Such a range format is used for convenience and brevity and thus, should be interpreted flexibly to include not only the numerical values explicitly recited as the limits of the range but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, amounts, sizes, formulations, parameters, and other quantities and characteristics are not and need not be exact but may be approximate, larger or smaller, as desired, reflecting tolerances, conversion factors, rounding, measurement error, and the like, and other factors known to those of skill in the art such that equivalent results or effects are obtained. In some circumstances, the value that provides equivalent results or effects cannot be reasonably determined. In such cases, as used herein, “about” and “at or about” mean the nominal value indicated ±10% variation unless otherwise indicated or inferred. In general, an amount, size, formulation, parameter, or other quantity or characteristic is “about,” “approximate,” or “at or about,” whether or not expressly stated to be such. Where “about,” “approximate,” or “at or about” is used before a quantitative value, the parameter also includes the specific quantitative value itself unless expressly stated otherwise.

As used herein, “optional” or “optionally” means that the subsequently described event or circumstance can or cannot occur. The description includes instances where said event or circumstance occurs and those where it does not.

As used herein, the term or phrase “effective,” “effective amount,” or “conditions effective to” refers to such amount or condition that is capable of performing the function or property for which an effective amount or condition is expressed. As will be pointed out below, the exact amount or particular condition required will vary from one aspect to another, depending on recognized variables such as the materials employed and the processing conditions observed. Thus, it is not always possible to specify an exact “effective amount” or “condition effective to.” However, it should be understood that an appropriate effective amount will be readily determined by one of ordinary skill in the art using only routine experimentation.

Although the operations of exemplary aspects of the disclosed method may be described in a particular sequential order for convenient presentation, it should be understood that disclosed aspects can encompass an order of operations other than the particular sequential order disclosed. For example, operations described sequentially may, in some cases, be rearranged or performed concurrently. Further, descriptions and disclosures provided in association with one particular aspect are not limited to that aspect and may be applied to any aspect disclosed.

As used herein, the term “substantially” means that the subsequently described event or circumstance completely occurs or that the subsequently described event or circumstance generally, typically, or approximately occurs.

Still further, the term “substantially” can, in some aspects, refer to at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

As used herein, the term “substantially,” in, for example, the context “substantially identical” or “substantially similar,” refers to a method or a system, or a component that is at least about 90%, at least about 91%, at least about 92%, at least about 93%, at least about 94%, at least about 95%, at least about 96%, at least about 97%, at least about 98%, at least about 99%, or about 100% by similar to the method, system, or the component it is compared to.

Compounds are described using standard nomenclature. Unless defined otherwise, all technical and scientific terms used herein have the same meaning as is commonly understood by one of skill in the art to which this disclosure belongs.

The compounds described herein include enantiomers, mixtures of enantiomers, diastereomers, tautomers, racemates, and other isomers, such as rotamers, as if each is specifically described unless otherwise indicated or otherwise excluded by context. It is to be understood that the compounds provided herein may contain chiral centers. Such chiral centers may be of either the (R) or (S) configuration. The compounds provided herein may either be enantiomerically pure or be diastereomeric or enantiomeric mixtures. Unless stated to the contrary, a formula with chemical bonds shown only as solid lines and not as wedges or dashed lines contemplates each possible isomer, e.g., each enantiomer, diastereomer, and meso compound, and a mixture of isomers, such as a racemic or scalemic mixture.

Compounds described herein may contain one or more double bonds and, thus, potentially give rise to cis/trans (E/Z) isomers, as well as other conformational isomers. Unless stated to the contrary, all such possible isomers are contemplated, as well as mixtures of such isomers.

Compounds described herein may also be present as an equilibrium of tautomers. For example, ketones with an α-hydrogen can exist in an equilibrium of the keto form and the enol form. Likewise, amides with an N-hydrogen can exist in an equilibrium of the amide form and the imidic acid form. Unless stated to the contrary, all possible tautomers of the compounds described herein are contemplated.

As used herein, the term “polyelectrolyte complex” refers to an association complex formed between oppositely charged macromolecules.

As used herein, the term “film” refers to condensed matter restricted in one dimension.

As used herein, the term “coating” refers to a layer of a composition that covers a surface.

As used herein, the term “tape” refers to a narrow strip of material used to hold or fasten.

As used herein, the term “packaging material” refers to a material to enclose, protect, and/or transport a product.

As used herein, “crosslink” refers to a bond or short sequence of bonds that links one polymer chain to another. The bonds may refer to covalent bonds, ionic bonds, electrostatic interactions, hydrogen bonds, and the like. In some aspects, the bonds may refer to covalent bonds. As used herein, a “crosslinker” may refer to a chemical used to promote the formation of the bonds that link the polymer chains. Any suitable crosslinker consistent with the objectives of this disclosure may be used.

Certain materials, compounds, compositions, and components disclosed herein can be obtained commercially or readily synthesized using techniques generally known to those of skill in the art. For example, the starting materials and reagents used in preparing the disclosed compounds and compositions are either available from commercial suppliers, such as Sigma-Aldrich (formally MilliporeSigma, Burlington, MA) or Thermo Fisher Scientific Inc. (Waltham, MA), or are prepared by methods known to those skilled in the art following procedures set forth in references such as Fieser and Fieser's Reagents for Organic Synthesis (John Wiley and Sons, 2007); Organic Reactions (John Wiley and Sons, 2004); March's Advanced Organic Chemistry, (John Wiley and Sons, 8^{th} Edition); and Larock's Comprehensive Organic Transformations (John Wiley and Sons, 3^{rd} edition, 2017).

### Polyelectrolyte Films

In a first aspect, an article is provided including a composition. In some aspects, the article can include a polyelectrolyte complex. In some aspects, the polyelectrolyte complex can be formed from a cellulose derivative and chitosan.

In some aspects, the article can be a film, a coating, a tape, a foam, a bulk material, or a packaging material. In some particular aspects, the article can be a film.

In some aspects, the article can be a packaging material. Representative examples of packaging materials include, but are not limited to, barrier bags, desiccant-integrated packaging, flexible pouches (including for food, pharmaceuticals, medical devices, and the like), liquid containers, and the like. Representative examples of applications of such packaging materials include, but are not limited to, protection and/or storage of electronics, semiconductors, aerospace equipment, food products, machinery parts, pharmaceuticals, medical devices, other sensitive equipment and materials, and the like. In some aspects, the packaging material may be a primary packaging, a secondary packaging, or a tertiary or transit packaging. In some aspects, the packaging material may be a packaging cushion.

In some aspects, the article may be a building material. Representative examples of such building materials include, but are not limited to, insulation and insulation boards, wall boards, building panels, building wraps, sheathing, precast concrete panels, and the like.

In some aspects, the article may be a bottle, a jar, a tray, a clamshell, a rigid container, a can, a carton (including a composite carton), a box, a fiberboard, a pouch, a bag, a sachet, a shrink wrap, a cling film, a blister pack, a laminated foil, a retort package, a crate, or a pallet.

Representative examples of suitable cellulose derivatives include, but are not limited to, carboxymethyl cellulose, cellulose phthalate, cellulose acetate phthalate, cellulose butyrate, cellulose acetate butyrate, cellulose phosphate, cellulose sulfate, oxidized cellulose, hypromellose phthalate, and the like.

In some aspects, the cellulose derivative can include carboxymethyl cellulose (CMC). In some aspects, the carboxymethyl cellulose can have a degree of substitution from about 0.4 to about 1.5, including exemplary values of 0.4, 0.5, 0.6, 0.7, 0.8, 0.9, 1.0, 1.1, 1.2, 1.3, 1.4, 1.5, or any subrange formed from the above exemplary values. In some aspects, carboxymethyl cellulose can have a degree of substitution of about 1.2.

In some aspects, the chitosan can be present in the composition in an amount from about 50% to about 75% by weight based on a total weight of the composition, including exemplary values of 50%, 52%, 55%, 57%, 60%, 62%, 65%, 67%, 70%, 72%, 75%, or any subrange formed from the above exemplary values. In some aspects, the chitosan can have a degree of ionization from about 20% to about 40%, including 20%, 22%, 25%, 27%, 30%, 32%, 35%, 37%, 40%, or any subrange formed from the above exemplary values.

In some aspects, the chitosan can have a degree of deacetylation from about 60% to about 100%, including exemplary values of 60%, 65%, 70%, 75%, 80%, 85%, 90%, 95%, 100%, or any subrange formed from the above exemplary values. In some aspects, the chitosan can have a degree of deacetylation of about 85%.

In some aspects, the composition can further be crosslinked with a crosslinker. In some aspects, the crosslinker can include citric acid (CA). In some aspects, the citric acid can be present in the composition in an amount from about 20% to about 30% by weight based on a total weight of the composition, including exemplary values of 20%, 21%, 22%, 23%, 24%, 25%, 26%, 27%, 28%, 29%, 30%, or any subrange formed from the above exemplary values. In some aspects, the citric acid can be present in the composition in an amount of about 25% by weight based on a total weight of the composition.

Thus, in another aspect, an article is provided including a composition, wherein the composition includes a crosslinked polyelectrolyte complex. In some aspects, the crosslinked polyelectrolyte complex can include a cellulose derivative (such as carboxymethyl cellulose), chitosan, and a crosslinker (such as citric acid), wherein the polyelectrolyte complex is crosslinked with the crosslinker.

In some aspects of the composition that includes the crosslinked polyelectrolyte complex, at a temperature of about 23° C. and a relative humidity from about 50% to about 75%, the composition can have a thickness-adjusted water vapor transmission rate (WVTR) from about 0.014 to about 4 g-mm/m²-day, including exemplary values of 0.014, 0.02, 0.03, 0.04, 0.05, 0.06, 0.07, 0.08, 0.09, 0.1, 0.2, 0.3, 0.4, 0.5, 0.6, 0.7, 0.8, 0.9, 1.0, 1.2, 1.4, 1.6, 1.8, 2.0, 2.2, 2.4, 2.6, 2.8, 3.0, 3.2, 3.4, 3.6, 3.8, 4.0, and any subrange formed from the above exemplary values. Thickness-adjusted water vapor transmission rates may be measured at a temperature of about 23° C. and a relative humidity of about 50%, about 55%, about 50%, about 65%, about 70%, or about 75%. As used herein, “water vapor transmission rate” refers to a measure of the passage of water vapor through a substance over a specific period of time, typically provided in units of g/m²-day. The water vapor transmission rate may be normalized to the thickness of a material in mm, measured in g-mm/m²-day, providing a “thickness-adjusted water vapor transmission rate (WVTR)” as described herein. Methods and instruments for measuring the water vapor transmission rate of a material are known in the art, for example, ASTM F1249-20.

In some aspects of the composition that includes the crosslinked polyelectrolyte complex, the composition can have a residual water content (RWC) from about 4% to about 6%, including exemplary values of 4%, 4.2%, 4.4%, 4.6%, 4.8%, 5%, 5.2%, 5.4%, 5.6%, 5.8%, 6%, and any subrange formed from the above exemplary values.

In some aspects, the article can be heat-treated.

In some aspects, the article can have a thickness from about 5 to about 100 microns, including exemplary values of 5, 10, 20, 30, 40, 50, 60, 70, 80, 90, or 100 microns, or any subrange formed from the above exemplary values.

In another aspect, a process is provided for manufacturing a film as described above.

In some aspects, the process can include preparing a first solution comprising the cellulose derivative (such as carboxymethyl cellulose) and a volatile acid, wherein the volatile acid can be present in the first solution in an amount to adjust the pH of the first solution from about 1 to about 2. In some aspects, the first solution is an aqueous solution. However, any suitable solvent consistent with the objectives of the disclosure may be used.

In some aspects, the process can include preparing a second solution comprising the chitosan and the volatile acid, wherein the volatile acid is present in the second solution in an amount to adjust the pH of the second solution from about 1 to about 2. In some aspects, the second solution is an aqueous solution. However, any suitable solvent consistent with the objectives of the disclosure may be used.

In some aspects, the process can include combining the first solution and the second solution to form a mixture. In some aspects, combining the first solution and the second solution can include dropwise addition of the first solution into the second solution or dropwise addition of the second solution into the first solution. In some aspects, combining the first solution and the second solution occurs under agitation, such as stirring.

In some aspects, the process can include casting and drying the mixture to form the film. In some aspects, casting the mixture can include drop-casting of the mixture.

As used herein, a “volatile acid” refers to an acid that readily evaporates at room temperature (about 23° C.), i.e., the acid easily transitions into a gaseous state. In some aspects, the volatile acid can include an organic acid. Representative examples of volatile acids include, but are not limited to, formic acid, acetic acid, propionic acid, butyric acid, isobutyric acid, valeric acid, isovaleric acid, and 2-methylbutyric acid. In some aspects, the volatile acid can include formic acid.

In some aspects, the first solution, the second solution, or both can further include a crosslinker (such as citric acid).

In some aspects, the process can further include heat treating the film. In some aspects, heat treating the film occurs at a temperature from about 100 to about 150° C., including exemplary values of 100, 105, 110, 115, 120, 125, 130, 135, 140, 145, or 150° C., or any subrange formed from the above values. In some aspects, heat treating the film occurs at a temperature of about 120° C.

### Citric Acid-Crosslinked Cellulosic Films

In other aspects, an article is provided including a composition, wherein the composition includes a cellulose or a cellulose derivative and citric acid (CA). In some aspects, the cellulose or cellulose derivative can be crosslinked with the citric acid. In some aspects, the citric acid can be present in an amount of about 25% by weight based on a total weight of the film.

In some aspects, the article can be a film, a coating, a tape, a foam, a bulk material, or a packaging material. In some particular aspects, the article can be a film.

In some aspects, the article can be a packaging material. Representative examples of packaging materials include, but are not limited to, barrier bags, desiccant-integrated packaging, flexible pouches (including for food, pharmaceuticals, medical devices, and the like), liquid containers, and the like. Representative examples of applications of such packaging materials include, but are not limited to, protection and/or storage of electronics, semiconductors, aerospace equipment, food products, machinery parts, pharmaceuticals, medical devices, other sensitive equipment and materials, and the like. In some aspects, the packaging material may be a primary packaging, a secondary packaging, or a tertiary or transit packaging. In some aspects, the packaging material may be a packaging cushion.

In some aspects, the article may be a building material. Representative examples of such building materials include, but are not limited to, insulation and insulation boards, wall boards, building panels, building wraps, sheathing, precast concrete panels, and the like.

In some aspects, the article may be a bottle, a jar, a tray, a clamshell, a rigid container, a can, a carton (including a composite carton), a box, a fiberboard, a pouch, a bag, a sachet, a shrink wrap, a cling film, a blister pack, a laminated foil, a retort package, a crate, or a pallet.

In some aspects, the composition can include cellulose and citric acid. In some aspects, the composition can include a cellulose derivative and citric acid. Representative examples of cellulose derivatives that can be used include, but are not limited to, carboxymethyl cellulose, cellulose phthalate, cellulose acetate phthalate, cellulose butyrate, cellulose acetate butyrate, cellulose phosphate, cellulose sulfate, oxidized cellulose, hydroxyethyl cellulose, hydroxypropyl cellulose, hypromellose phthalate, and the like. In some aspects, the cellulose derivative can include carboxymethyl cellulose (CMC).

In some aspects, at a temperature of about 23° C. and a relative humidity up to about 65%, the composition can have a thickness-adjusted water vapor transmission rate (WVTR) of less than about 0.02 g-mm/m²-day.

In some aspects, the article can be heat-treated.

In some aspects, the article can have a thickness from about 5 to about 100 microns, including exemplary values of 5, 10, 20, 30, 40, 50, 60, 70, 80, 90, or 100 microns, or any subrange formed from the above exemplary values.

In some aspects, a process for manufacturing a film as described herein is provided. In some aspects, the process includes preparing a solution of the cellulose derivative (such as carboxymethyl cellulose) and the citric acid. In some aspects, the solution can be an aqueous solution. However, any suitable solvent consistent with the objectives of the disclosure may be used.

In some aspects, the process can include casting and drying the mixture to form the film. In some aspects, casting the mixture can include drop-casting of the mixture. However, other suitable methods for casting films can be used. In some aspects, drying the mixture may comprise any suitable method known for drying cast films.

In some aspects, the process can further include heat treating the film. In some aspects, heat treating the film occurs at a temperature from about 100 to about 150° C., including exemplary values of 100, 105, 110, 115, 120, 125, 130, 135, 140, 145, or 150° C., or any subrange formed from the above values. In some aspects, heat treating the film occurs at a temperature of about 120° C.

A number of aspects of the disclosure have been described. Nevertheless, it will be understood that various modifications may be made without departing from the spirit and scope of the invention. Accordingly, other aspects are within the scope of the following claims.

By way of non-limiting illustration, examples of certain aspects of the present disclosure are given below.

### EXAMPLES

The following examples are set forth below to illustrate the compositions, articles, devices, and methods claimed herein, along with associated methods and results according to the disclosed subject matter. These examples are not intended to be inclusive of all aspects of the subject matter disclosed herein, but rather to illustrate representative methods and results. These examples are not intended to exclude equivalents and variations of the present disclosure, which are apparent to one skilled in the art.

Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

### Example 1. Polyelectrolyte Complex Films of Polysaccharides

Polysaccharides are the most abundant class of natural polymers, making them attractive starting materials to design renewable alternatives to petroleum-based plastics for high-volume applications such as packaging. However, their profound moisture sensitivity, a direct result of their hydrophilic side groups, makes them susceptible to plasticization in high moisture environments, leading to drastic changes in their physical properties and impeding their utilization. Typical approaches to limit their moisture sensitivity, such as chemical crosslinking or functionalization, are complicated by the highly variable side group chemistry of different polysaccharides, often involving ionized/ionizable moieties. In this example, we show that polyelectrolyte complexation is an approach to limit the hydration of ionized side groups and design moisture-resistant polysaccharide-based barrier films. To demonstrate efficacy approach, we use carboxymethyl cellulose (CMC) and chitosan (CH), two commercially available polysaccharides, as a model polyelectrolyte complex (PEC) system. We find that the degree of ionization of CMC and CH in PEC films depends on the processing pH and the specific acid or base used to control pH. Films processed from hydrochloric acid solution are more distorted, discolored, and inhomogeneous compared to films processed from formic acid solution at the same pH. Increasing the number of intrinsic ion pairs by varying the processing conditions or film composition leads to properties consistent with increased moisture resistance including decreased water vapor transmission rate (WVTR). We also find that this approach is easily implemented concurrently with chemical crosslinking of hydroxyl groups, resulting in a WVTR as low as 6.6 g-mm/m²-day at 23° C. and 80% RH, approaching the range of some traditional packaging plastics, such as poly(ethylene terephthalate), polystyrene, and poly(vinyl chloride) under humid conditions.

### Introduction

Considering their natural abundance, polysaccharides are an underutilized class of polymers, partially due to their notorious sensitivity to moisture which stems from their hydrophilic moieties. There is broad interest, for example, in displacing petroleum-based packaging materials with more sustainable alternatives such as cellulose and other polysaccharides, but their high water vapor transmission rates have limited their performance, particularly at high humidities.

The moisture sensitivity of polysaccharides can be limited to some extent by crosslinking via their abundant available hydroxyl groups. However, many polysaccharides also contain ionized or ionizable side groups either by nature (e.g., alginate, poly(galacturonic acid), poly(hyaluronic acid), or chitosan) or by design (e.g., carboxymethyl cellulose, TEMPO-oxidized cellulose, cellulose nanocrystals, or cationic cellulose), which do not necessarily participate in crosslinking reactions under the same conditions. These ionic moieties are easily hydrated, thus even highly crosslinked polysaccharide materials may undergo substantial physical changes in high moisture environments.

Consequently, in addition to crosslinking, polyelectrolyte complexation has been probed as a concurrent approach to control the moisture sensitivity of polysaccharides by limiting swelling and hydration of ionizable side groups. In general, polyelectrolyte complexes (PECs) are easily obtained by mixing solutions of oppositely charged polyelectrolytes, making their processing relatively straightforward compared to the lengthy ion exchange required to prepare films crosslinked by multivalent ions. Strongly associated, salt-free PECs form insoluble glassy solids, which hydrate to different extents depending on pH, salt concentration, and temperature. Thus, highly associated PECs are promising for limiting moisture sensitivity and water permeability in polysaccharide-based films. However, the extent of intrinsic ion pairing is scarcely considered in the preparation of polysaccharide-based PEC films.

In this example, we explore the moisture sensitivity of polysaccharide-based films formed from PECs over a wide range of ion pairing, and aim to elucidate process-structure-property relationships. We use carboxymethyl cellulose (CMC) and chitosan (CH), both commercially abundant polysaccharides and weak polyelectrolytes, as a model system to explore highly tunable processing parameters which enable the design of PECs with tailored ion pairing and moisture sensitivity.

### Results and Discussion

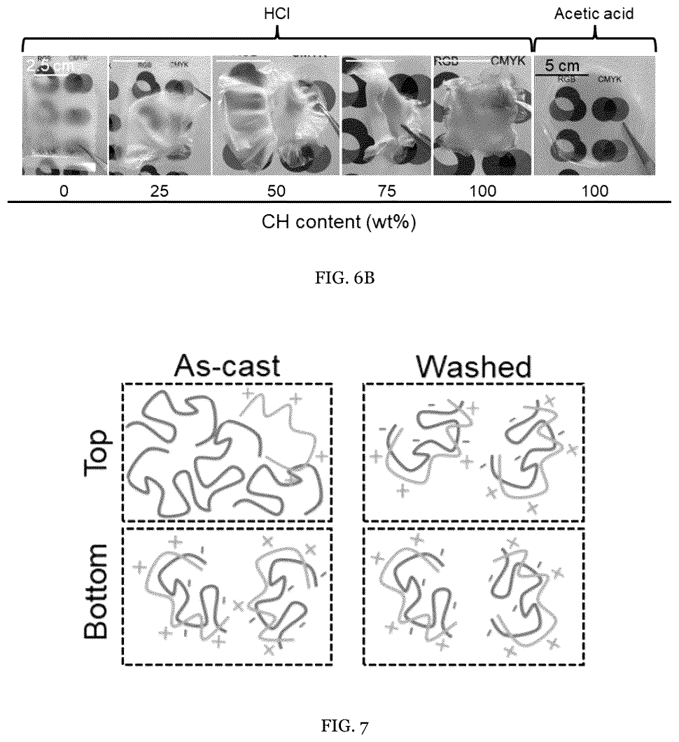

While PECs are easy to obtain, processing them into continuous, homogeneous films can be difficult due to their tendency to form insoluble complexes. Thus, we start our experiments by exploring different mixing conditions for CMC and CH. We dissolved CMC and CH in deionized water and 5 vol % acetic acid, respectively, to obtain 1 wt % solutions, which we then mixed in equal mass at different ionic strength and pH. Precluding mixing, different amounts of sodium chloride (NaCl) and 0.7 M hydrochloric acid (HCl) or 0.6 M sodium hydroxide (NaOH) were added to CMC and CH solutions to obtain the desired ionic strength and pH (FIGS. 6A-6B).

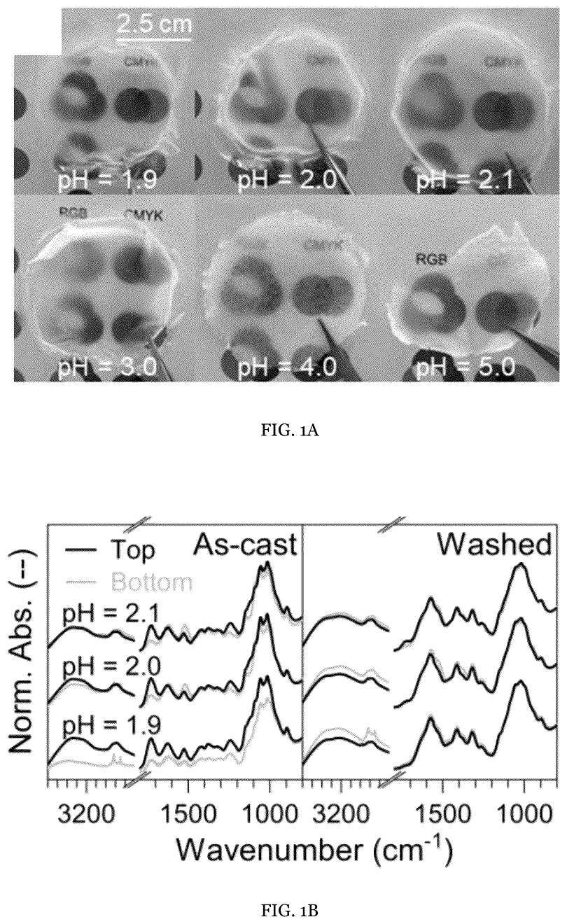

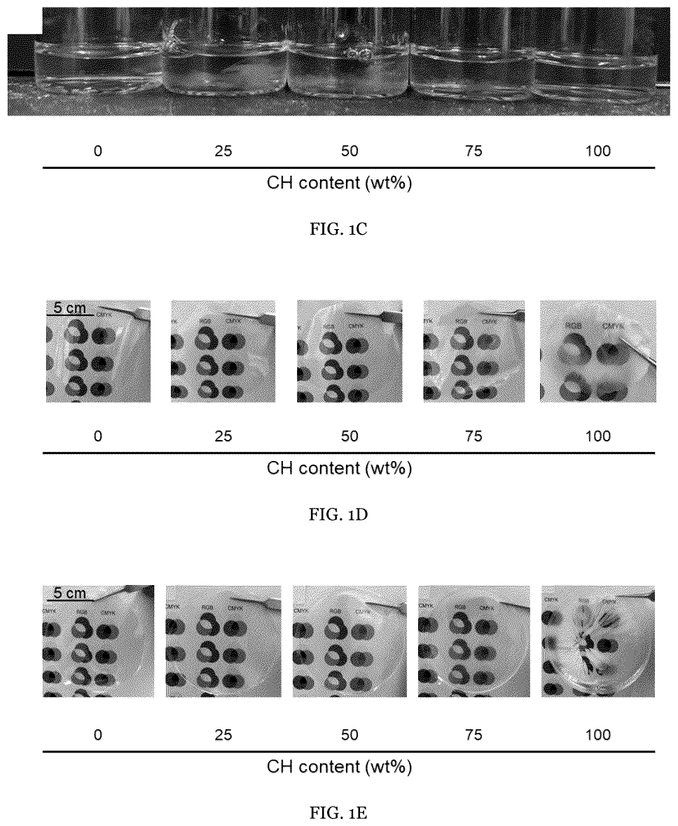

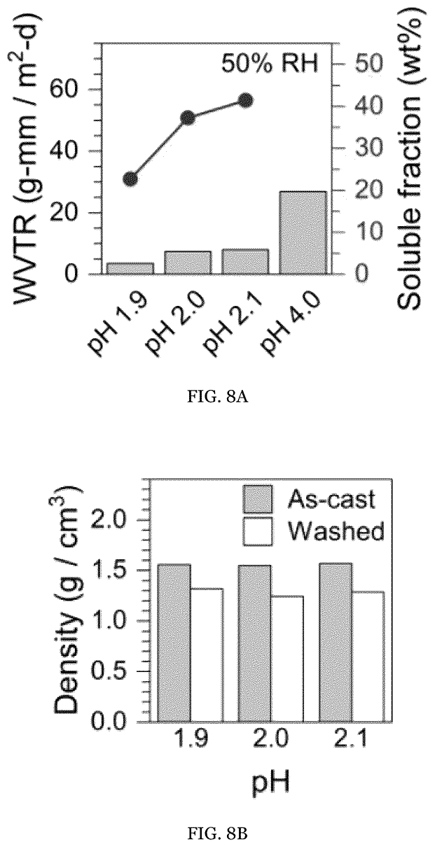

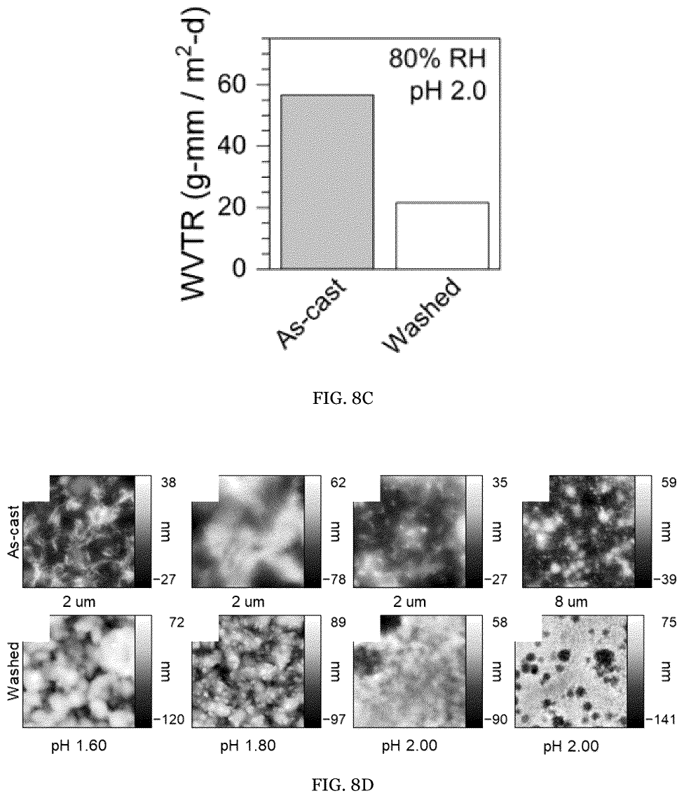

With sufficiently high ionic strength at a pH of 2, it is possible to obtain a fully soluble mixture of CMC and CH without forming any precipitates (FIG. 6A). However, drying films from solutions with high ionic strength results in PEC films with excess salt, leading to crystallization of the salt, increased extrinsic ion pairing, and increased swelling and moisture sensitivity (see inset in FIG. 6A). Thus, we focus only on CMC/CH mixtures with no excess salt. In this case, it is difficult to obtain films unless the mixture pH is very low (pH<2) due to aggregation at higher pH (FIG. 6A). However, CMC/CH films dried from HCl solution with pH 1.6 are distorted and discolored, likely due to degradation caused by HCl (FIG. 6B). Raising the pH slightly (pH=1.9-2.1) after mixing gives more visibly homogeneous films, but generates excess salt, shown in FIG. 1A (see FIGS. 8A-8D for details), and closer investigation reveals that the films are vertically inhomogeneous, i.e., their composition likely varies throughout their thickness, indicated by the differences in FTIR spectra when measured on either side of the film (FIG. 1B). The characteristic carbonyl stretching vibration of protonated carboxylic acids (1720 cm⁻¹) absorbs more prominently on the ‘top’ side compared to the ‘bottom’ side, suggesting that the average protonation state of CMC is not constant through the film thickness.

Hence, we replaced HCl with 95% formic acid (FA), a volatile weak acid with reduced propensity to degrade polysaccharides. Using this approach to mix CMC and CH at a pH of 1.8, despite some aggregation visible in FIG. 1C, we obtain good quality freestanding films after air-drying in a polystyrene petri dish at ambient temperature (FIG. 1D). After air-drying, films were heat-treated in a convection oven at 120° C. for 2 hours to remove residual solvent. Notably, there is no indication from FTIR that films dried from formic acid solution vary in composition throughout their thickness. While not wishing to be bound by any one theory, trapped HCl may be responsible for the inhomogeneity of CMC/CH films dried from HCl solution (see FIG. 1B). A small amount of deprotonated CMC moieties may form complexes with CH which settle to the bottom of the mixture during drying, while most of the highly protonated CMC may remain dissolved in solution and ultimately dries on top of the CMC/CH complex layer, as illustrated in FIG. 7, resulting in the discrepancy observed in FTIR. In fact, after washing the films in an excess of deionized water to remove trapped HCl, the FTIR spectra of either side of the films are nearly identical (FIG. 1B, right panel), supporting the view that trapped HCl is responsible for the inhomogeneity of the films. Conversely, the homogeneity of CMC/CH films dried from formic acid solution suggests that formic acid has a greater propensity to evaporate during the drying process compared to HCl.

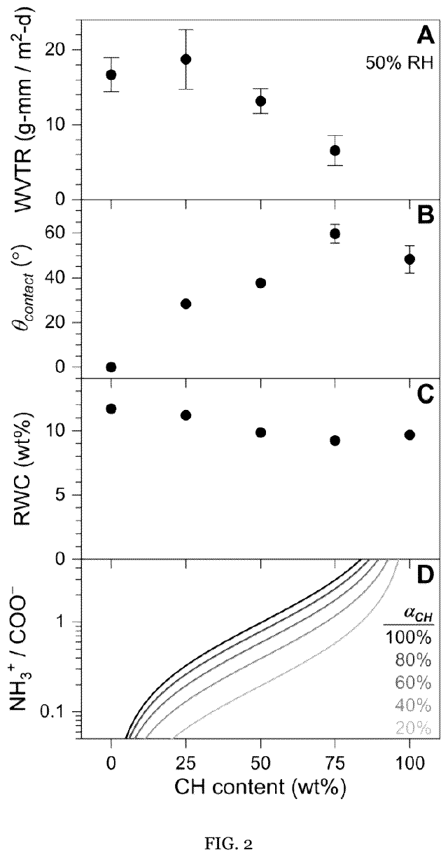

The WVTR of CMC/CH films decreases with increasing CH content, presumably due to the varying number of intrinsic ion pairs, which is well known to control molecular mobility in PECs (FIG. 2, panel A). The WVTR of the neat CH film was higher than the detection limit of the instrument, substantiating a possible theory that intrinsic ion pairing leads to synergistically lower WVTR. This is consistent with other PEC systems, where both oxygen and water permeabilities are composition dependent but always lower than the neat materials. Other indicators of moisture resistance such as the contact angle (FIG. 2, panel B) and residual water content (FIG. 2, panel C) indicate that CMC/CH blend films are more hydrophobic and retain less water under ambient conditions compared to neat CMC or CH, consistent with the trend we see in the WVTR. Based on the degrees of substitution and deacetylation of CMC and CH, respectively, maximum pairing of ionizable side groups occurs very near 50 wt % CH (FIG. 2D, black line). However, films with 75 wt % CH consistently exhibit the highest moisture resistance, considering their low WVTR (FIG. 2, panel A), relatively high contact angle (FIG. 2, panel B), and low residual water content (FIG. 2, panel C). Therefore, if the moisture resistance of CMC/CH films is a result of intrinsic ion pairing between ammonium (NH₃⁺) and carboxylate (COO⁻) groups on CH and CMC, respectively, then there must be an excess of ionized carboxylate moieties compared to ammonium at 50 wt % CH which become paired at 75 wt % CH.

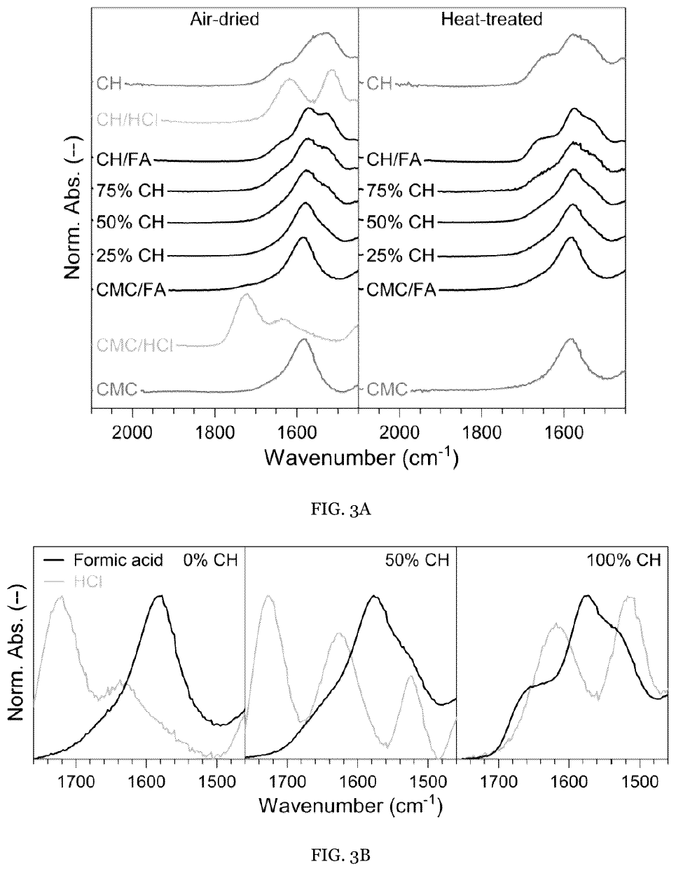

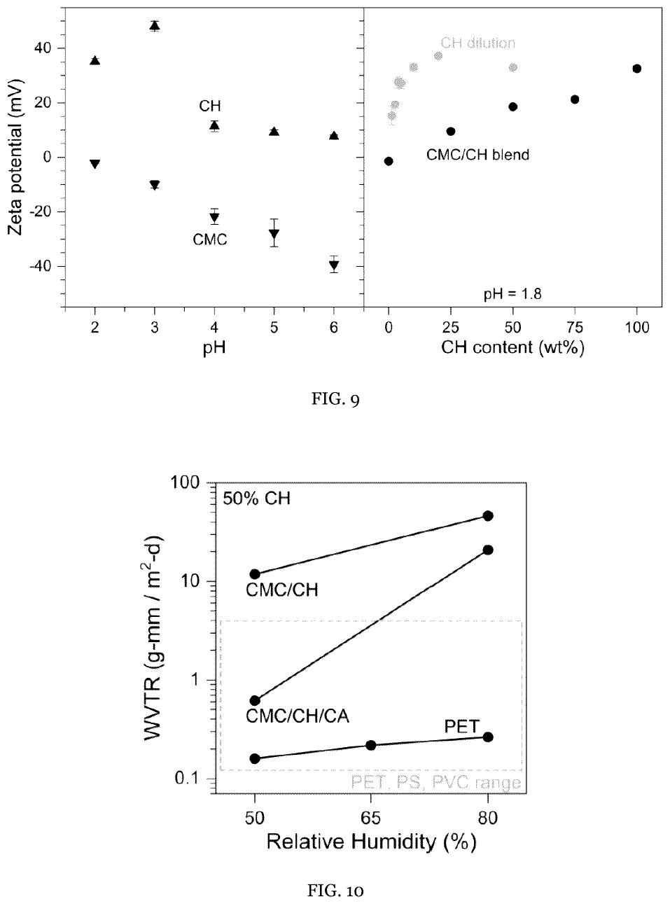

To corroborate the theory that intrinsic ion pairing is responsible for the improved moisture resistance of CMC/CH films, we employed FTIR to elucidate the degree of ionization of CMC and CH in the solid state. Films dried from HCl solution provide a convenient reference to infer the degree of ionization of CMC and CH in the dry state. For example, the spectrum of CMC dried from HCl solution (CMC/HCl) confirms that neutralized CMC is easily identified by the carbonyl stretching vibration of carboxylic acids (COOH, 1720 cm⁻¹), which is completely absent in all CMC/CH films dried from formic acid solution (FIG. 3A, left panel). CMC transitions from essentially fully neutralized in solution, indicated by the near-zero zeta potential of CMC in formic acid solution with pH=2 (FIG. 9, left panel), to fully ionized in the solid state.

The ionization of CH is not so easily quantified due to convoluted vibrations of key functional groups, summarized in Table 1. Nonetheless, stark differences in the spectra of highly ionized CH dried from HCl solution (denoted CH/HCl) compared to CH dried from formic acid solution (denoted CH/FA) indicate that CH is only partially ionized in the solid state (FIG. 3A, left panel). Specifically, the ammonium N—H bending vibration (NH₃⁺, 1620 cm⁻¹) prominent in the spectrum of CH/HCl is completely undetectable in CH/FA films due to the relatively increased intensities of the amide carbonyl stretching (NHCOCH₃, 1650 cm⁻¹) and amine N—H bending (NH₂, 1571 cm⁻¹) vibrations (FIG. 3A, left panel). The amine N—H bending vibration (NH₂, 1571 cm⁻¹) is even more distinguished after heat treatment, presumably due to evaporation of residual formic or acetic acid and thus decreased ionization of CH (FIG. 3A, right panel). CH appears to be only partially ionized in CMC/CH films as well, indicated by the similar spectral line shapes of CMC/CH films, which increasingly resemble that of neat CH as the CH content increases (FIG. 3A).

TABLE 1
FTIR bond assignments for spectra in FIGS. 3A-3B

| Wavenumber | | |
|---|---|---|
| (cm⁻¹⁾ | Bond assignment | Component |
| 1513 | Amide N—H bending (NHCOCH₃) | CH |
| 1571 | Amine N—H bending (NH₂) | CH |
| 1585 | Carboxylate C═O stretching (COO⁻) | CMC |
| 1620 | Ammonium N—H bending (NH₃⁺) | CH |
| 1650 | Amide C═O stretching (NHCOCH₃) | CH |
| 1720 | Carboxylic acid C═O stretching (COOH) | CMC |

Although we cannot quantify the degree of ionization of CH, we consider the spectra of films dried from HCl solution (pH=1.9), represented by the grey lines in FIG. 3B, as a qualitative reference. The pronounced absorption at 1720 cm-1 in the spectra of neat CMC confirms that CMC is highly protonated under these conditions (FIG. 3B, left panel, grey line). While not wishing to be bound by any one theory, CH dried from HCl solution may be essentially fully ionized, supported by the clear ammonium N—H bending vibration (NH₃⁺, 1620 cm⁻¹) and complete absence of the neutral amine N—H bending vibration (NH₂, 1571 cm⁻¹) in neat CH (FIG. 3B, right panel, grey line).

The spectra of CMC/CH (50 wt % CH) is markedly different when dried from HCl solution compared to the equivalent film dried from formic acid solution (FIG. 3B, middle panel). When CMC and CH are dried from HCl solution and thus both fully protonated, their respective characteristic vibrations (i.e., COOH 1720 cm⁻¹ and NH₃⁺ 1620 cm⁻¹) are clearly distinguished, while the characteristic vibrations of their fully deprotonated forms (COO⁻ 1585 cm⁻¹ and NH₂ 1571 cm⁻¹, respectively) are completely absent (FIG. 3B, middle panel, grey line). Conversely, we see essentially the inverse spectrum when the film is dried from formic acid solution—there are no distinct vibrations above 1600 cm⁻¹, suggesting that most primary amine groups on CH are deprotonated (FIG. 3B, middle panel, black line). While not wishing to be bound by any one theory, CH in CMC/CH films dried from formic acid solution may be far from 100% ionized, consistent with the trends in FIG. 2, which suggest that the degree of ionization of CH is in the range of 20-40% (FIG. 2, panel D).

The theory that intrinsic ion pairing is the key parameter affecting the moisture sensitivity of CMC/CH films may be supported by previous work which identifies the number of intrinsic ion pairs to be important for many properties of PECs such as relaxation time, glass transition temperature, and thus molecular mobility, all of which are influential to permeability of small molecules. However, the molar ratio of water to intrinsic ion pairs plays an equally important role by affecting chain mobility, and is strongly influenced by pH or mixing ratio for weak or strong polyelectrolytes, respectively. Therefore, we must also consider how the degree of hydration per intrinsic ion pair of CMC/CH films may affect their moisture sensitivity.

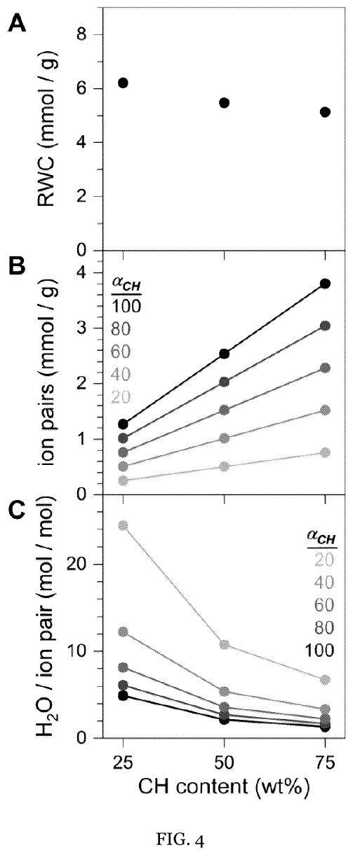

As the CH content increases from 25 to 75 wt %, the residual water content of CMC/CH films changes only slightly, by about 18% (FIG. 4, panel A), while the number of intrinsic ion pairs changes by 300% or more over the same composition range (FIG. 4, panel B). Thus, considering that the degree of CH ionization is far less than 100%, the molar ratio of water to intrinsic ion pairs likely decreases substantially with increasing CH content (FIG. 4, panel C). Therefore, the combined effect of increased number of intrinsic ion pairs and lower degrees of hydration per ion pair lead to improved moisture resistance in CMC/CH films with 75 wt % CH.

The WVTR of CMC/CH films, while low compared to many bio-based materials, is quite high compared to commercial barrier plastics. Thus, to further reduce WVTR, we introduce citric acid (CA), a well-known crosslinker for polysaccharides, to chemically crosslink hydroxyl groups of CMC and CH in addition to physical crosslinks formed between ionized moieties.

We prepared CMC/CH films crosslinked by CA (CMC/CH/CA), pictured in FIG. 1E, using the same method described earlier for CMC/CH films, including heat treatment at 120° C. for 2 hours, with the modification that CA was dissolved in CMC and CH solutions before adjusting their pH and mixing. The CA content was held constant for all films at 25 wt % with respect to the total mass to ensure there will be a slight excess of monomers over moles of crosslinker, though the degree of crosslinking is unoptimized. Films comprising only CH and CA were excluded for some characterizations due to the poor quality of the films (FIG. 1E).

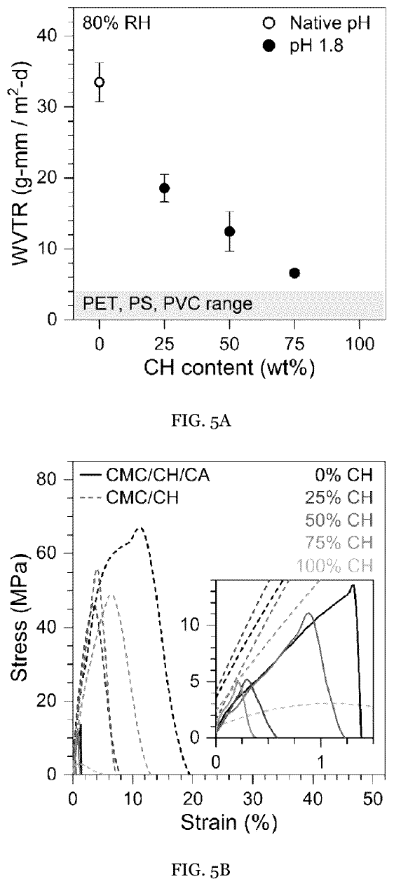

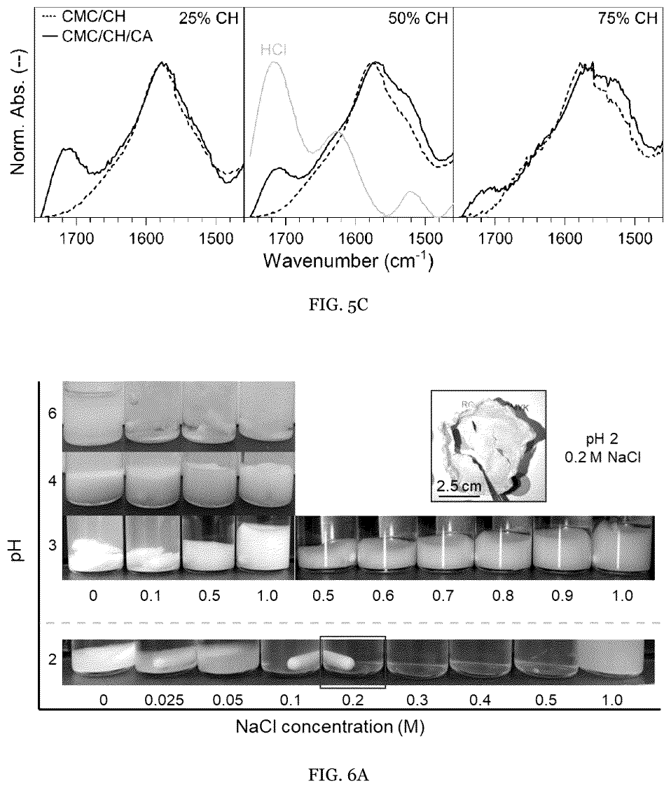

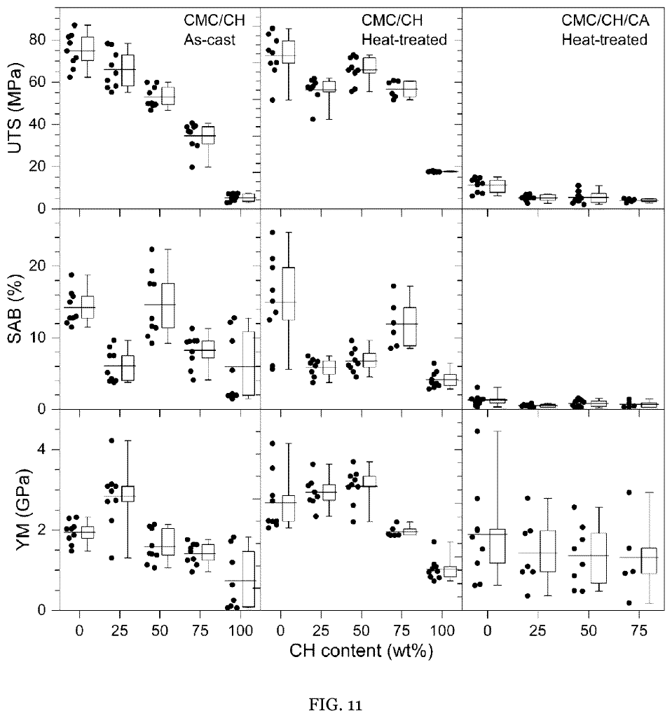

The WVTR of CMC/CH/CA films approaches the range of some traditional packaging plastics, such as poly(ethylene terephthalate), polystyrene, and poly(vinyl chloride), even at 80% RH (FIG. 5A). The WVTR of CMC/CH/CA at 50% RH is much lower than at 80% RH, and well within the range of commercial barrier plastics (FIG. 10).

Addition of CA, a nonvolatile acid, does not substantially change the composition with the lowest WVTR. Due to the acidity of the first proton of CA (see Table 2) the degree of ionization of CMC or CH to change, shifting the mass ratio of CMC/CH where one-to-one ion pairing occurs. A cursory look at the FTIR spectra of CMC/CH/CA films seemingly supports this expectation, considering the increased intensity of the carbonyl stretching and N—H bending vibrations characteristic of neutral CMC (COOH, 1720 cm⁻¹) and ionized CH (NH₃⁺, 1620 cm⁻¹), respectively, compared to the spectra of CMC/CH films (FIG. 5C). However, addition of CA introduces many more convoluted vibrations, including the carbonyl stretching vibrations of free CA (COO⁻, 1585 cm⁻¹ and COOH, 1720 cm⁻¹) as well as N—H bending and carbonyl stretching vibrations of amides and esters (NHCOCH₃, 1513 cm⁻¹; NHCOCH₃, 1650 cm⁻¹; COOR, 1720 cm⁻¹) if the films are crosslinked.

TABLE 2
Acidities of the ionizable constituents
used in preparing CMC/CH/CA films.

| Components | pKa |
|---|---|
| Citric acid (1) | 3.10 |
| Formic acid | 3.75 |
| CMC | 4.30 |
| Citric acid (2) | 4.70 |
| Acetic acid | 4.76 |
| CH | 6.0-6.5 |
| Citric acid (3) | 6.40 |

Crosslinking by CA seems likely considering the dramatically reduced breaking strain of CMC/CH blend films when CA is added, highlighted in FIG. 5B. Despite small differences in the representative stress-strain curves of CMC/CH/CA films, the degree of crosslinking does not appear to vary significantly with CH content when we consider their average mechanical properties (see FIG. 11). This is further substantiated by the thermal behavior of CMC/CH/CA films, including their residual water content.

Thus, it is ambiguous whether the spectral changes in CMC/CH/CA films compared to CMC/CH are a result of changes in the degree of ionization of CMC or CH, or crosslinking by CA. However, it is clear from FIG. 5C that CMC and/or CH are not 100% protonated in CMC/CH/CA films. While not wishing to be bound by any one theory, it is plausible that even when citric acid is present, CMC is highly ionized while CH is not—thus the composition of lowest WVTR still lies between 50 and 100 wt % CH.

### Conclusion

We have shown that intrinsic ion pairs formed by blending oppositely charged polysaccharides directly lead to reduced moisture sensitivity, including lower water vapor transmission rates, compared to the neat materials. The approach can be easily combined with other strategies to control moisture sensitivity, such as chemical crosslinking, to achieve excellent WVTR nearing the range of commercial water barrier plastics even at 80% relative humidity.

However, it is critical that the processing method is carefully designed to tune the degree of ionization and thus intrinsic ion pairing in the solid state. The simplest parameters to control are the blend composition and the type of acid or base added to the mixture. Non-volatile acids or bases will encourage various degrees of protonation or deprotonation of weak polyelectrolytes in the solid state depending on their relative acidities, while volatile alternatives (e.g., formic acid, ammonium hydroxide) will evaporate, and the degree of ionization will be largely determined by the equilibrium between polyelectrolytes. This example highlights the potential of polysaccharide-based] high-barrier packaging materials with competitive performance even in extremely humid environments. There is much room to optimize the degree of crosslinking and intrinsic ion pairing to achieve even higher performance than was demonstrated herein.

### Materials and Methods

### Materials

Sodium carboxymethyl cellulose (CMC) with a degree of substitution of 1.2 and weight-average molecular weight (Mw) of 250,000 g/mol was obtained from Sigma Aldrich. Chitosan (CH) with a degree of deacetylation of 85% was obtained from Thermo Scientific. ACS reagent grade sodium chloride (NaCl, ≥99.0%), ACS reagent grade citric acid (CA) monohydrate (≥99.0%), ACS reagent grade glacial acetic acid (≥99.7%), reagent grade formic acid (FA, ≥95%), and ACS reagent grade hydrochloric acid (HCl, 37%) were obtained from Sigma Aldrich.

### Preparation of CMC and CH Solutions

A parent CMC solution was prepared by dissolving 10.0 g CMC in 990.0 mL deionized water to obtain a 1.0 wt % CMC solution. Similarly, a parent CH solution was prepared by dissolving 10.0 g CH in a mixture of 940.0 mL deionized water and 50.0 mL glacial acetic acid to yield a 1.0 wt % CH solution.

### Preparation of CMC/CH Films

To prepare CMC/CH films, concentrated formic acid (95%) was added to aliquots of the parent CMC and CH solutions until the pH was measured to be 1.8 using a Mettler Toledo SevenExcellence Multiparameter pH meter. After adjusting the pH of CMC and CH solutions, different volumes of CH were added dropwise to CMC under vigorous stirring to obtain CMC/CH mixtures with 0, 25, 50, 75, and 100 wt % CH with respect to the total solids content (FIG. 1C).

The CMC/CH mixtures were transferred to a polystyrene petri dish and dried in a fume hood under ambient conditions. The films were peeled from the petri dish to obtain “as-cast” freestanding films with approximately 100 mm diameter and 50 mm thickness (FIG. 1D). Unless otherwise indicated, the films were heat-treated by drying in a convection oven at 120° C. for 2 hours to remove residual solvent.

To prepare CMC/CH films crosslinked by CA (i.e., CMC/CH/CA films) shown in FIG. 1E, enough CA monohydrate was dissolved in aliquots of the parent CMC and CH solutions to yield 25 wt % CA with respect to the total solids content. Otherwise, the films were prepared using the same procedure described above. All CMC/CH/CA films were heat-treated to remove residual water and volatile acids, and to promote chemical reaction between CA and CMC or CH.

### Water Vapor Transmission Rate (WVTR)

As-cast films were cut to the appropriate size using scissors, and their thickness measured using a micrometer and calculated as the average of at least 10 measurements at different points on the film. Each film was masked using adhesive aluminum foil allowing for 0.71-2.85 cm² of exposed film area depending on the sample and test condition. The masked films were heat-treated as described herein and stored at ambient conditions for at least one day before testing.

Water vapor transmission rate (WVTR) was measured at 23° C. using a MOCON PERMATRAN-W 1/50 WVTR Analyzer. The dry side humidity was maintained at 5% RH while the wet side humidity was set to 50 or 80% RH. The WVTR was normalized for film thickness according to the equation below, where WVTR is the thickness-normalized WVTR (g-mm/m²-day), WVTRₒ is the absolute WVTR (g/m²-day), and L is the average film thickness (mm).

$$WVTR = {WVTR}_{O} \times L$$

### Contact Angle

CMC/CH solutions were prepared as described herein and spin coated onto glass substrates (treated by UV-ozone) at 500 rpm for 5 minutes and stored in a vacuum desiccator (<0.01 MPa) overnight. The samples were heat-treated as described herein, and again stored in a vacuum desiccator overnight.

Contact angle was measured using a ramé-hart automated contact angle goniometer model 290-G1 and DROPimage Advanced analysis software. A droplet of deionized water was applied to the surface of the sample, and the contact angle was reported as the average and standard deviation of at least three measurements on each side of the droplet.

Calculation of NH₃⁺/COO⁻ Molar Ratio

The molar ratio of ammonium (NH₃⁺) to carboxylate (COO⁻) groups for films with different wt % and ionization of CH was calculated according to the equation below, where ach is the degree of ionization of CH (i.e., a_{CH}=NH₃⁺/[NH₃⁺+NH₂]), DDA is the degree of deacetylation of chitosan (DDA=85% in this example), x_{CH} is the mass fraction of chitosan, MW_{CH} is the average molecular weight of a chitosan monomer with DDA=85% (MW_{CH}=167.46 g/mol), DS is the degree of substitution of CMC, and MW_{CMC} is the average molecular weight of a CMC monomer with DS=1.2 (MW^{CMC}=231.79 g/mol).

$${mol}^{{NH}_{3}^{+}} / {mol}^{{COO}^{-}} = \frac{{α}_{CH} ( DDA ) {x}_{CH} / {MW}_{C H}}{( DS ) ( 1 - {x}_{CH} ) / {MW}_{CMC}}$$

### Zeta Potential of CMC, CH, and CMC/CH Blends

The zeta potential of CMC/CH solutions was measured at different pH (FIG. 9, left panel) and CMC/CH mass ratio (FIG. 9, right panel) using a Malvern Zetasizer Nano. The total solids concentration was maintained at 0.5 wt % by adjusting the pH of CMC and CH parent solutions (1 wt %) using formic acid, followed by dilution with formic acid solution with the equivalent pH. We also measured the zeta potential of neat CH solutions at pH 1.8 and different dilutions to demonstrate that the signal does not decrease with decreasing CH concentration until the mass ratio is less than 25 wt % CH.

### Thermal Analysis and Residual Water Content

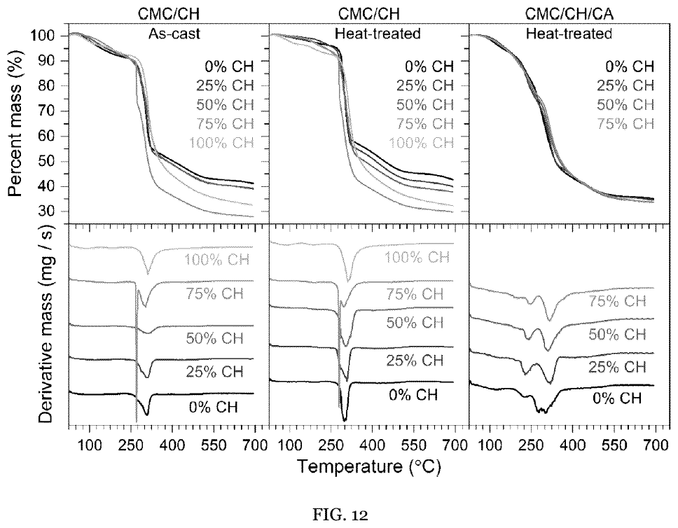

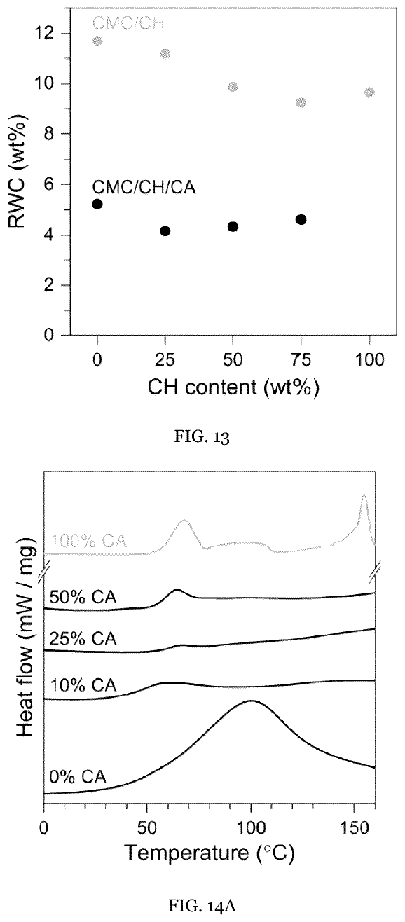

Thermogravimetric analysis (TGA) was measured from 25 to 700° C. at a rate of 20° C./min using a Mettler Toledo TGA/DSC 3+ STAR system. The measured sample mass was divided by the initial mass to calculate the percent mass, shown in FIG. 12. Residual water content (RWC) was defined as the total mass loss between 25° C. and 150° C. and calculated according to the equation below, where m₂₅ and m₁₅₀ are the sample mass at 25° C. and 150° C., respectively.

$$RWC = \frac{{m}_{25} - {m}_{150}}{{m}_{25}}$$

Differential scanning calorimetry (DSC) was measured from −90 to 160° C. at a rate of 20° C./min using a Mettler Toledo DSC 3+ STAR system. Heat flow was normalized by the initial sample mass.

### Fourier Transform Infrared Spectroscopy (FTIR)

Fourier transform infrared spectroscopy (FTIR) was measured using a Nicolet 6700 FTIR equipped with a diamond crystal attenuated total reflectance (ATR) attachment. The absorbance was measured from 400 to 4000 cm⁻¹ using 64 scans and a resolution of 4 cm⁻¹, and the resulting spectra were normalized to scale from 0 to 1 based on their minimum and maximum absorbance.

### Calculation of Hydration of Intrinsic Ion Pairs

The residual water content was used to calculate the number of water molecules per intrinsic ion pair. We assume that CMC is always 100% ionized, while the degree of ionization of CH (a_{CH}) may vary. We also assume that for each a_{CH}, maximum intrinsic ion pairing is achieved between CMC and CH. Hence, from the residual water content (RWC), degree of ionization of CMC and CH, and CH content, we can calculate the molar ratio of water to intrinsic ion pairs over a range of CH ionization, shown in FIG. 4, using the equation below, where M_{W} is the molecular weight of water, and M_{CH} is the molecular weight of chitosan with a degree of deacetylation (DDA) of 85%.

$$Water per ion pair = \frac{( RWC ) {M}_{W} {M}_{CH}}{{x}_{CH} ( DDA ) {α}_{CH}}$$

### Soluble Fraction of CMC/CH Films

CMC/CH films were stored in a vacuum desiccator (<0.01 MPa) for at least three days, and the mass of the dry films was measured. The films were soaked in an excess of deionized water (approximately 100 mL) for at least 72 hours. The water was decanted and the films were dried under ambient conditions, then stored in a vacuum desiccator for at least three days. The mass of each film was measured again, and the dissolved fraction was calculated according to the equation below, where m1 and m2 are the mass of the film before and after soaking in water, respectively.

$$Soluble fraction = \frac{{m}_{1} - {m}_{2}}{{m}_{1}} \times 100$$

### Density of CMC/CH Films

Density was measured using the Archimedes method. Films were dried in a vacuum desiccator (<0.01 MPa) for at least three days before measuring their dry mass. The mass was immediately measured again while the films were suspended in heptane (0.684 g/cm³). The density of the films was calculated according to the equation below, where d_{H} is the density of heptane, and m₁ and m₂ are the mass of the film while dry and submerged in heptane, respectively.

$$Film density = \frac{{d}_{H} {m}_{1}}{{m}_{1} - {m}_{2}} \times 100$$

### Mechanical Properties of CMC/CH and CMC/CH/CA Films

Upper tensile strength (UTS), strain at break (SAB), and Young's modulus (YM) were measured using a high-throughput mechanical characterization (HTMECH) instrument. In short, films were sandwiched between two perforated plates. The samples were punctured by a blunt needle through the perforated plates at different locations on the film. The force, displacement, and contact time were used to calculate stress/strain behavior of the films.

### Determination of Appropriate Mixing Parameters

To prepare polyelectrolyte complexes (PECs) of CMC and CH, enough 0.7 M HCl was added to equal volume aliquots of the parent CMC and CH solutions to obtain solutions with the desired mixing pH, measured using a Mettler Toledo SevenExcellence Multiparameter pH meter. The pH-adjusted aliquots were partitioned equally into smaller volumes, and NaCl was dissolved in each solution to obtain CMC/NaCl and CH/NaCl solutions with different NaCl concentrations. CMC and CH solutions with equivalent pH and NaCl concentrations were then mixed by adding CH dropwise to CMC under vigorous stirring.

At high pH (pH=6), CMC/CH mixtures formed solid PECs or gels, depending on the ionic strength (FIG. 6A). At lower pH (pH=3-4), solid PECs swelled with increasing ionic strength, but no gelation occurred. At very low pH (pH=2), CMC/CH PECs may be solid-like, liquid-like (coacervates), or fully soluble in a single phase, by varying ionic strength from 0 to 0.5 M NaCl. At pH=2 and 1 M NaCl, the mixture is not soluble due to salting out of CMC, CH, or both.

At pH<1.9, CMC/CH mixtures are clear and do not form visible precipitates, even in salt-free solutions (o M NaCl). However, the quality of films dried from low pH HCl solutions is poor (FIG. 6B). We attribute the poor film quality to degradation caused by HCl, which is supported by the much better film quality of neat CH dried from acetic acid solution rather than HCl at the same pH. Unfortunately, CMC/CH mixtures are insoluble in acetic acid solution even with pH<2, which we reason is a consequence of the comparable pKa of CMC and acetic acid (4.30 and 4.76, respectively). Essentially, acetic acid cannot sufficiently protonate CMC to prevent aggregation with CH due to their similar acidities.

To minimize acid degradation while still avoiding precipitation of CMC/CH mixtures, we mixed CMC and CH at a pH of 1.6 as described above and raised the pH by adding 0.6 M NaOH before drying. However, we found that the resulting films were inhomogeneous throughout their thickness according to FIG. 1B—a simplified representation of the heterogeneous composition of the films is provided in FIG. 7.

Additionally, this preparation method results in excess salt generation as a byproduct of the neutralization of HCl with NaOH. We found that adding increasing amounts of NaOH to raise the pH of the CMC/CH mixture resulted in a consistent increase in WVTR with increasing final pH (FIG. 8A)—an unexpected trend considering that the number of intrinsic ion pairs should increase as the pH is raised above 2 (see FIG. 9). The soluble fraction of the films followed a similar trend (FIG. 8A), and the density of the films after washing and redrying was decreased substantially (FIG. 8B), suggesting that a significant portion of the films are more dense than the rest, but also more hydrophilic and soluble. Indeed, after washing away the soluble fraction, the WVTR decreases substantially (FIG. 8C). Atomic force microscopy of similar films is telling. When no NaOH is added to the CMC/CH mixture, there appear to be small, fiber-like aggregates of CMC and CH (FIG. 8D). As more NaOH is added to raise the pH, more spherical aggregates appear (FIG. 8D), but washing the films in an excess of deionized water reveals crater-like features in the topography of the films, presumably where salt crystals were dissolved from the film (FIG. 8D). In the regions outside of the salt crystals, washing seems to have the opposite effect, causing the aggregates to grow and densify, apparent in FIG. 8D, which we attribute to the increased complexation of CMC and CH as the pH is raised (residual acid is washed out of the film) and the number of intrinsic ion pairs is increased.

In summary, from FIGS. 1A-1B, FIGS. 6A-6B, and FIGS. 8A-8D, we conclude that making good quality CMC/CH blend films requires that i) the mixing pH of CMC and CH is less than approximately 2, ii) the acid used to adjust the pH has a sufficiently low pKa such that it can protonate CMC to a high degree, iii) the acid causes minimal degradation reactions of CMC and CH, iv) the acid is sufficiently volatile such that it evaporates during drying and does not cause phase separation in the CMC/CH blend film, and v) no excess salt is added to the mixture, and the amount of salt generated is minimized by avoiding the mixture of acid and base in the same solution.

### Water Vapor Transmission Rate of CMC/CH and CMC/CH/CA Films

The WVTR of CMC/CH/CA films is much lower than that of CMC/CH films, and is well within the range of traditional water barrier plastics such as poly(ethylene terephthalate) (PET), polystyrene (PS), and poly(vinyl chloride) (PVC) at 50% RH (FIG. 10).

### Differential Scanning Calorimetry of Films Comprising CMC, CH, and CA

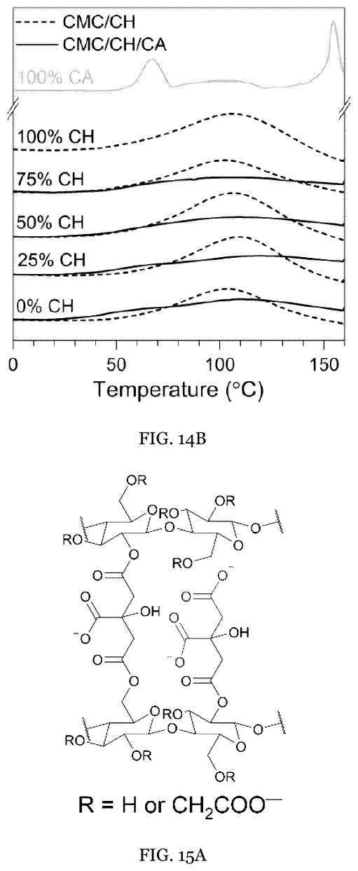

Hydrated CA forms a complex with water which is reversible at temperatures lower than 100° C., depending on the heating rate. When heated at 20° C./min, the dehydration endotherm of neat citric acid monohydrate is clearly identified at approximately 65° C. in FIGS. 14-14B. In polymer films comprising CA, this endotherm is still prominent if the CA is not crosslinked, evidenced by the endotherm in FIG. 14A for a CMC film containing excess CA (50 wt %). However, in highly crosslinked films, such as CMC containing 25 wt % CA, the endotherm essentially vanishes (FIG. 14A).

The dehydration endotherm of CA is discernable to a small extent in CMC/CH/CA films with 0-25 wt % CH and disappears entirely when the CH content is 50 wt % or higher, indicating that CMC/CH/CA films are highly crosslinked (FIG. 14B).

### REFERENCES FOR EXAMPLE 1

1. Vartiainen, J. et al. Comparison of properties between cellulose nanofibrils made from banana, sugar beet, hemp, softwood and hardwood pulps. O Pap 76, 51-54 (2015).
2. Sharma, S. et al. Thermally enhanced high performance cellulose nano fibril barrier membranes. RSC Adv. 4, 45136-45142 (2014). f
3. Rincon, E. et al. Effect of Bay Leaves Essential Oil Concentration on the Properties of Biodegradable Carboxymethyl Cellulose-Based Edible Films. Materials (Basel) 12 (2019).
4. Ebrahimzadeh, S., Ghanbarzadeh, B. & Hamishehkar, H. Physical properties of carboxymethyl cellulose based nano-biocomposites with Graphene nano-platelets. Int J Biol Macromol 84, 16-23 (2016).
5. Oun, A. A. & Rhim, J. W. Preparation and characterization of sodium carboxymethyl cellulose/cotton linter cellulose nanofibril composite films. Carbohydr Polym 127, 101-109 (2015).
6. Sprockel, O. L., Prapaitrakul, W. & Shivanand, P. Permeability of Cellulose Polymers: Water Vapour Transmission Rates. Journal of Pharmacy and Pharmacology 42, 152-157 (1990).
7. Xia, J. et al. Highly transparent 100% cellulose nanofibril films with extremely high oxygen barriers in high relative humidity. Cellulose 25, 4057-4066 (2018).
8. Tong, Q., Xiao, Q. & Lim, L.-T. Preparation and properties of pullulan-alginate-carboxymethylcellulose blend films. Food Research International 41, 1007-1014 (2008).
9. Zabihollahi, N., Alizadeh, A., Almasi, H., Hanifian, S. & Hamishekar, H. Development and characterization of carboxymethyl cellulose based probiotic nanocomposite film containing cellulose nanofiber and inulin for chicken fillet shelf life extension. Int J Biol Macromol 160, 409-417 (2020).
10. Soni, B., Hassan, E. B., Schilling, M. W. & Mahmoud, B. Transparent bionanocomposite films based on chitosan and TEMPO-oxidized cellulose nanofibers with enhanced mechanical and barrier properties. Carbohydr Polym 151, 779-789 (2016).
11. Schnell, C. N. et al. Films from xylan/chitosan complexes: preparation and characterization. Cellulose 24, 4393-4403 (2017).
12. Ponnusamy, P. G., Sundaram, J. & Mani, S. Preparation and characterization of citric acid crosslinked chitosan-cellulose nanofibrils composite films for packaging applications. Journal of Applied Polymer Science (2021).
13. Nuruddin, M. et al. Gas and Water Vapor Barrier Performance of Cellulose Nanocrystal-Citric Acid-Coated Polypropylene for Flexible Packaging. ACS Applied Polymer Materials 2, 4405-4414 (2020).
14. Ghanbarzadeh, B., Almasi, H. & Entezami, A. A. Improving the barrier and mechanical properties of corn starch-based edible films: Effect of citric acid and carboxymethyl cellulose. Industrial Crops and Products 33, 229-235 (2011).
15. Beghetto, V. et al. Development of 4-(4,6-dimethoxy-1,3,5-triazin-2-yl)-4-methylmorpholinium chloride cross-linked carboxymethyl cellulose films. Carbohydr Polym 249, 116810 (2020).
16. Azeredo, H. M. C. & Waldron, K. W. Crosslinking in polysaccharide and protein films and coatings for food contact—A review. Trends in Food Science & Technology 52, 109-122 (2016).
17. Chi, K. & Catchmark, J. M. in Green Polymer Chemistry: New Products, Processes, and Applications Vol. 1310 (eds H. N. Cheng, Richard A. Gross, & Patrick B. Smith) Ch. 8, (American Chemical Society, 2018).
18. Chi, K. & Catchmark, J. M. Improved eco-friendly barrier materials based on crystalline nanocellulose/chitosan/carboxymethyl cellulose polyelectrolyte complexes. Food Hydrocolloids 80, 195-205 (2018).
19. Chi, K., Wang, H. & Catchmark, J. M. Sustainable starch-based barrier coatings for packaging applications. Food Hydrocolloids 103 (2020).
20. Chi, K., He, J., Lin, W. S., Bokhari, S. M. Q. & Catchmark, J. M. Electrostatically Complexed Natural Polysaccharides as Aqueous Barrier Coatings for Sustainable and Recyclable Fiber-Based Packaging. ACS Appl Mater Interfaces 15, 12248-12260 (2023).
21. Wang, Q. & Schlenoff, J. B. The Polyelectrolyte Complex/Coacervate Continuum. Macromolecules 47, 3108-3116 (2014).
22. Kabanov, V. A. Polyelectrolyte complexes in solution and in bulk. Russian Chemical Reviews 74, 3-20 (2005).
23. Shimizu, M., Saito, T. & Isogai, A. Water-resistant and high oxygen-barrier nanocellulose films with interfibrillar cross-linkages formed through multivalent metal ions. Journal of Membrane Science 500, 1-7 (2016).
24. Manoj Lalwani, S., Eneh, C. I. & Lutkenhaus, J. L. Emerging trends in the dynamics of polyelectrolyte complexes. Phys Chem Chem Phys 22, 24157-24177 (2020).
25. Fares, H. M., Wang, Q., Yang, M. & Schlenoff, J. B. Swelling and Inflation in Polyelectrolyte Complexes. Macromolecules 52, 610-619 (2019).
26. Shiratori, S. S. & Rubner, M. F. pH-Dependent Thickness Behavior of Sequentially Adsorbed Layers of Weak Polyelectrolytes. Macromolecules 33, 4213-4219 (2000).
27. Kim, S. J., Shin, S. R., Lee, K. B., Park, Y. D. & Kim, S. I. Synthesis and characteristics of polyelectrolyte complexes composed of chitosan and hyaluronic acid. Journal of Applied Polymer Science 91, 2908-2913 (2004).
28. Cárdenas, A., Argüelles-Monal, W., Goycoolea, F. M., Higuera-Ciapara, I. & Peniche, C. Diffusion Through Membranes of the Polyelectrolyte Complex of Chitosan and Alginate. Macromolecular Bioscience 3, 535-539 (2003).
29. Heinze, T., Seoud, O. A. E. & Koschella, A. Cellulose Derivatives. 1 edn, (Springer Cham, 2018).
30. Hasan, S., Boddu, V. M., Viswanath, D. S. & Ghosh, T. K. Chitin and Chitosan. 1 edn, (Springer Cham, 2022).
31. Zhang, Y. et al. Molecular Origin of the Glass Transition in Polyelectrolyte Assemblies. ACS Cent Sci 4, 638-644 (2018).
32. Suarez-Martinez, P. C., Batys, P., Sammalkorpi, M. & Lutkenhaus, J. L. Time-Temperature and Time-Water Superposition Principles Applied to Poly(allylamine)/Poly(acrylic acid) Complexes. Macromolecules 52, 3066-3074 (2019).
33. Yamashita, Y. & Endo, T. Deterioration behavior of cellulose acetate films in acidic or basic aqueous solutions. Journal of Applied Polymer Science 91, 3354-3361 (2004).
34. K. M. Vårum, M. H. Ottøy & O. Smidsrød. Acid hydrolysis of chitosans. Carbohydrate Polymers 46, 89-98 (2001).
35. Sikorski, D., Gzyra-Jagiela, K. & Draczynski, Z. The Kinetics of Chitosan Degradation in Organic Acid Solutions. Mar Drugs 19 (2021).
36. Lalwani, S. M., Batys, P., Sammalkorpi, M. & Lutkenhaus, J. L. Relaxation Times of Solid-like Polyelectrolyte Complexes of Varying pH and Water Content. Macromolecules 54, 7765-7776 (2021).
37. Batys, P., Zhang, Y., Lutkenhaus, J. L. & Sammalkorpi, M. Hydration and Temperature Response of Water Mobility in Poly(diallyldimethylammonium)-Poly(sodium 4-styrenesulfonate) Complexes. Macromolecules 51, 8268-8277 (2018).
38. Zhang, Y., Li, F., Valenzuela, L. D., Sammalkorpi, M. & Lutkenhaus, J. L. Effect of Water on the Thermal Transition Observed in Poly(allylamine hydrochloride)-Poly(acrylic acid) Complexes. Macromolecules 49, 7563-7570 (2016).
39. Li, J., van Ewijk, G., van Dijken, D. J., van der Gucht, J. & de Vos, W. M. Single-Step Application of Polyelectrolyte Complex Films as Oxygen Barrier Coatings. ACS Appl Mater Interfaces 13, 21844-21853 (2021).
40. Materials Science of Membranes for Gas and Vapor Separation. (John Wiley & Sons, Ltd., 2006).
41. Gusev, A. A., Müller-Plathe, F., Gunsteren, W. F. v. & Suter, U. W. in Atomistic Modeling of Physical Properties Vol. 116 Advances in Polymer Science 207-247 (Springer, Berlin, Heidelberg, 1994).
42. Nair, S. S., Zhu, J., Deng, Y. & Ragauskas, A. J. High performance green barriers based on nanocellulose. Sustainable Chemical Processes 2 (2014).
43. de Souza, G., Belgacem, M. N., Gandini, A. & Carvalho, A. J. F. Low permeable hydrophobic nanofibrilated cellulose films modified by dipping and heating processing technique. Cellulose (2021).
44. Lange, J. & Wyser, Y. Recent innovations in barrier technologies for plastic packaging—a review. Packaging Technology and Science 16, 149-158 (2003).
45. Massey, L. K. Film Properties of Plastics and Elastomers. Second Edition edn, (William Andrew Publishing, 2004).
46. Wang, J. et al. Moisture and Oxygen Barrier Properties of Cellulose Nanomaterial-Based Films. ACS Sustainable Chemistry & Engineering 6, 49-70 (2017).
47. Keller, P. E. & Kouzes, R. Water Vapor Permeation in Plastics. (Pacific Northwest National Laboratory, 2016).
48. McKeen, L. W. Permeability Properties of Plastics and Elastomers. (Elsevier Science & Technology Books, 2011).
49. Steven, M. D. & Hotchkiss, J. H. Comparison of flat film to total package water vapour transmission rates for several commercial food wraps. Packaging Technology and Science 15, 17-27 (2002).
50. Quellmalz, A. & Mihranyan, A. Citric Acid Cross-Linked Nanocellulose-Based Paper for Size-Exclusion Nanofiltration. ACS Biomater Sci Eng 1, 271-276 (2015).
51. Demitri, C. et al. Novel superabsorbent cellulose-based hydrogels crosslinked with citric acid. Journal of Applied Polymer Science 110, 2453-2460 (2008).
52. Ciriminna, R., Meneguzzo, F., Delisi, R. & Pagliaro, M. Citric acid: emerging applications of key biotechnology industrial product. Chem Cent J 11, 22 (2017).
53. Reddy, N. & Yang, Y. Citric acid cross-linking of starch films. Food Chemistry 118, 702-711 (2010).
54. Martínez, A., Vargas, R. & Galano, A. Citric acid: A promising copper scavenger. Computational and Theoretical Chemistry 1133, 47-50 (2018).
55. Goldberg, R. N., Kishore, N. & Lennen, R. M. Thermodynamic Quantities for the Ionization Reactions of Buffers. Journal of Physical and Chemical Reference Data 31, 231-370 (2002).
56. Kim, M. H., Kim, C. S., Lee, H. W. & Kim, K. Temperature dependence of dissociation constants for formic acid and 2,6-dinitrophenol in aqueous solutions up to 175° C. Journal of the Chemical Society, Faraday Transactions 92, 4951-4956 (1996).
57. Wang, X.-x. et al. The comparison of pKa determination between carbonic acid and formic acid and its application to prediction of the hydration numbers. Chemical Physics Letters 460, 339-342 (2008).
58. Dutra, F. R., Silva, C. S. & Custodio, R. On the Accuracy of the Direct Method to Calculate pK(a) from Electronic Structure Calculations. J Phys Chem A 125, 65-73 (2021).
59. Zhivkov, A. M. in Cellulose: Fundamental Aspects (eds Theo van de Ven & Louis Godbout) Ch. 8, (2013).
60. Samuelsen, L., Holm, R., Lathuile, A. & Schonbeck, C. Buffer solutions in drug formulation and processing: How pK(a) values depend on temperature, pressure and ionic strength. Int J Pharm 560, 357-364 (2019).
61. Wang, Q. Z. et al. Protonation constants of chitosan with different molecular weight and degree of deacetylation. Carbohydrate Polymers 65, 194-201 (2006).
62. Zhuang, L., Zhi, X., Du, B. & Yuan, S. Preparation of Elastic and Antibacterial Chitosan-Citric Membranes with High Oxygen Barrier Ability by in Situ Cross-Linking. ACS Omega 5, 1086-1097 (2020).
63. Sormana, J.-L., Chattopadhyay, S. & Carson Meredith, J. High-throughput mechanical characterization of free-standing polymer films. Review of Scientific Instruments 76 (2005).
64. Hyde, A. M. et al. General Principles and Strategies for Salting-Out Informed by the Hofmeister Series. Organic Process Research & Development 21, 1355-1370 (2017).
65. Zhang, P., Alsaifi, N. M., Wu, J. & Wang, Z.-G. Salting-Out and Salting-In of Polyelectrolyte Solutions: A Liquid-State Theory Study. Macromolecules 49, 9720-9730 (2016).
66. Apelblat, A. Citric Acid. (Springer, 2014).

### Example 2. Low-Water-Permeability Foils Based on Bio-Renewable Cellulose Derivatives

Packaging is one of the largest contributors to plastic waste. Hence, polymers produced from renewable sources have become attractive to substitute or fully replace petroleum-based plastics in packaging materials. However, the properties of some of the prime candidates—e.g., cellulose and its derivatives—rapidly deteriorate already at a modest relative humidity rendering them impractical for use in packaging products. In this example, we show by the example of carboxymethyl cellulose that chemical crosslinking with citric acid can be exploited to precisely control the moisture sensitivity of cellulose-based structures. Specifically, we demonstrate that the water vapor transmission rate (WVTR) of carboxymethyl cellulose can be manipulated in a controlled fashion over three orders of magnitude. Thereby, the lowest WVTR value, obtained for an optimal crosslinker content, is one order of magnitude lower than that measured for poly(ethylene terephthalate) even at a relatively humidity of up to 65%. This example, thus, clearly illustrates that cellulose-based materials can be made insensitive to humidity, which is not only of great importance for providing a solution towards more sustainable plastic packaging but, generally, for expanding the scope of applications of cellulose and its derivatives, allowing us to leverage their natural abundance, chemical versatility, and biodegradability.

### Introduction

Petroleum-sourced plastics, including single-use packaging materials, have become ubiquitous in our daily life because of their low-cost manufacturability, versatility, and, in many cases, their soft nature. Indeed, a world without plastics is nowadays difficult to imagine. Yet, our strong dependence on this materials class has led to drastic amounts of plastic waste finding its way into landfills and the environment. It is clear that reducing the use of plastics on the consumer side is not foreseeable in the near future. Hence, alternative materials systems that are renewable and easily degradable need to be advanced to meet the stringent property requirements of packaging materials. This includes ease of processing, biodegradability, mechanical properties, as well as water and oxygen permeability that both need to be low in a broad range of environments.

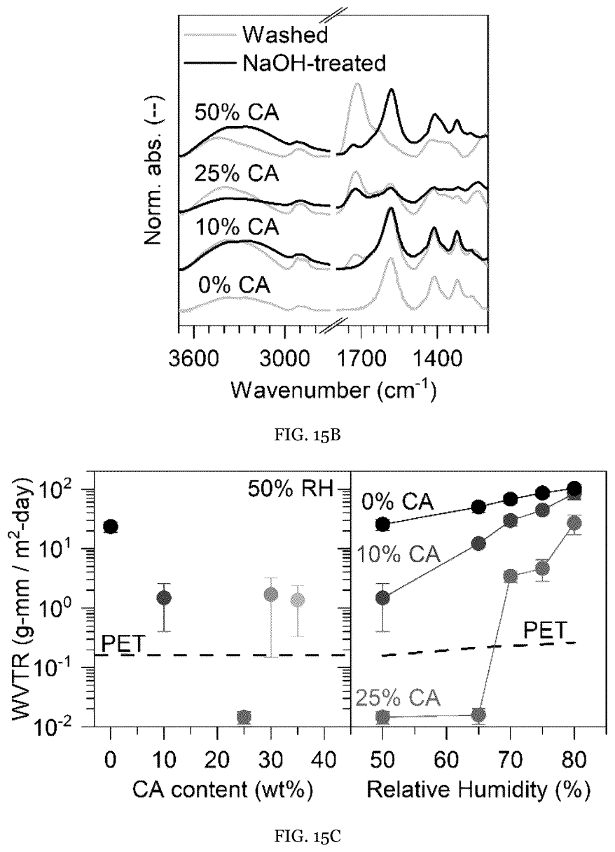

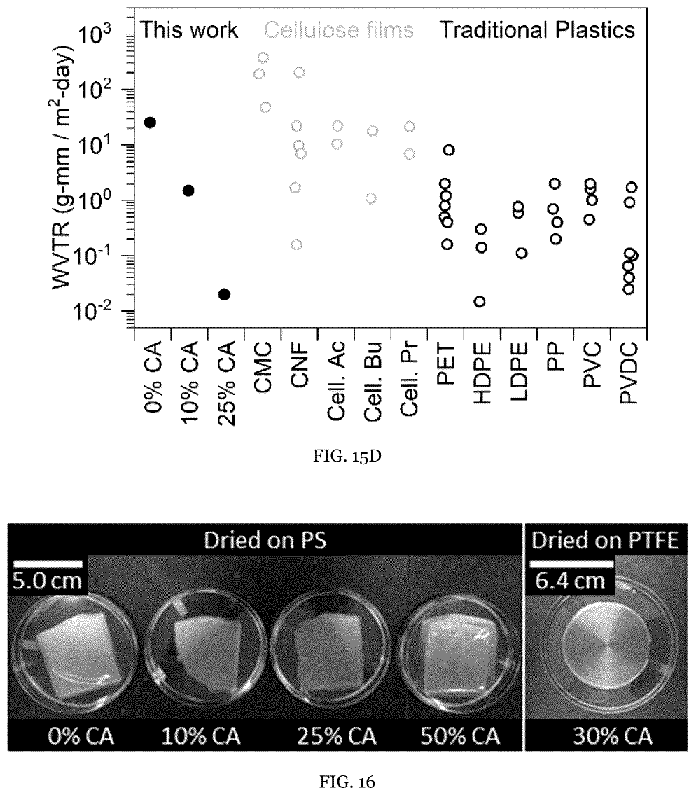

Cellulose-based systems have attracted increasing attention for use in packaging, among other reasons, because these relatively green plastics can feature excellent barrier properties, at least in the dry state. However, their highly hygroscopic nature renders cellulose materials extremely sensitive to humidity. This sensitivity can be reduced by reducing the materials' propensity to interact with water, e.g., by hornification or physical crosslinking by multivalent ions, but these processes are specific to certain morphologies and chemistries, and therefore not generalizable for different cellulose materials. Straight-forward chemical crosslinking of cellulose-based materials may offer another efficient route to control the sensitivity of cellulose materials to relative humidity (RH) and, generally, render the properties of these renewable plastics less sensitive to the environment. Some evidence consistent with this has been provided in literature, but by using uncontrolled or narrow ranges of crosslinker content and RH. We use here carboxymethyl cellulose (CMC) as a model system and explore whether crosslinking with citric acid (CA) via esterification, a reaction that leads to crosslinks as illustrated in FIG. 15A, can be exploited to limit the water vapor transmission characteristics of cellulose materials. The process is straight-forward and results in low water vapor transmission rates (WVTR) up to relative humidity levels of 65%.

### Results and Discussion

We begin this example with CMC/CA film preparation. First, 1.0 wt % CMC solutions were produced in deionized water. Subsequently, CA was added at room temperature at different concentrations. The resulting CMC/CA solutions were then cast at ambient conditions into either polystyrene (typically, CA content of <35 wt %) or polytetrafluoroethylene dishes (CA content of 25 and 35 wt %). These films were left to dry for approximately two weeks at ambient conditions, leading to homogenous structures of 5×5 cm² dimensions and a thickness of approximately 50 to 100 microns, as the photographs in FIG. 16 illustrate. To remove water and promote crosslinking, the films were after that dried in an oven at 120° C. for 2 hours.

We first assessed whether CA successfully crosslinked CMC under these conditions. For this we employed infrared (IR) spectroscopy and monitored vibrations characteristic for ester bonds (and, hence, crosslinking) focusing on the stretching vibration at 1718 cm⁻¹. Vice versa, the signature feature for carboxylic acid moieties at 1585 cm⁻¹ was also used as they are only present in CMC or unreacted CA. Our data is summarized in FIG. 15B, gray spectra.

A few observations can be made. Clear evidence of esterification can already be made in films of a CA content of 10 wt % only. Specifically, distinctive signals for ester moieties become apparent at 1718 cm⁻¹ upon introduction of this relatively small amount of CA—a feature that becomes more intense for samples where more CA was added (FIG. 15B, gray spectra). In parallel, the 1585 cm⁻¹ vibration characteristic for carboxylic acid moieties is decreasing in intensity with increasing CA content, further supporting the view of successful crosslinking.

Reassuringly, systems with even modest CA content display drastically decreased WVTR values—by more than three orders of magnitude (FIG. 15C). As a result, at 50% RH and 25 wt % CA, the WVTR value is 10 times lower than that recorded for poly(ethylene terephthalate) (PET), one of the most used barrier materials in packaging (FIG. 15C, left panel). This performance is maintained up to a RH of 65% (FIG. 15C, right panel), demonstrating how the simple tool of crosslinking via esterification can be exploited to render cellulose-materials such as CMC rather insensitive to the environment. Indeed, only high-density polyethylene (HDPE) and poly(vinylidene chloride) (PVDC) have similar performance (FIG. 1D), but these polymers are non-biodegradable and substantial contributors to plastic waste pollution.

The question remains why an optimal composition/CA content is found at 25 wt %. At higher content, the WVTR values increase significantly (FIG. 15C, left panel). We attribute this observation to the presence of unreacted or only partially reacted crosslinker, highlighted in FIG. 15A. In order to gain some additional insights, we exposed our CMC/CA films to a sodium hydroxide (NaOH) treatment to deprotonate remaining free acid groups so that unreacted or partially reacted CA can be detected.

The IR spectra of such treated CMC/CA films are displayed in FIG. 15B, black spectra. The comparison of the CMC/CA (25 wt %) and CMC/CA (50 wt %) systems is telling. For the former, no drastic spectral changes are observed after NaOH exposure, indicating that in these films, most carboxylic acid groups in the crosslinker are consumed. In contrast, for CMC/CA (50 wt %), after the NaOH treatment, the intensity of the 1585 cm⁻¹ vibration notably increases while the 1718 cm⁻¹ feature essentially is lost—an observation from which we conclude that in these films a considerable amount of excess CA or partially reacted CA is present.

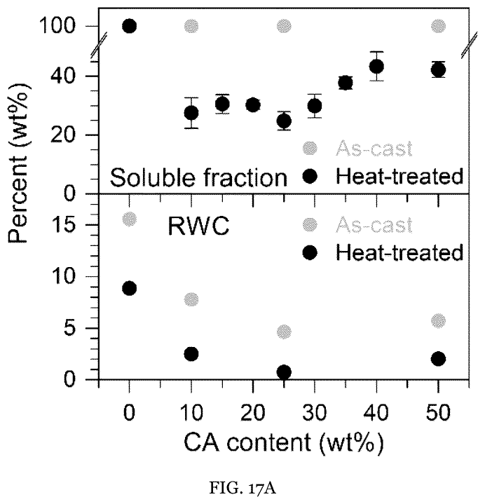

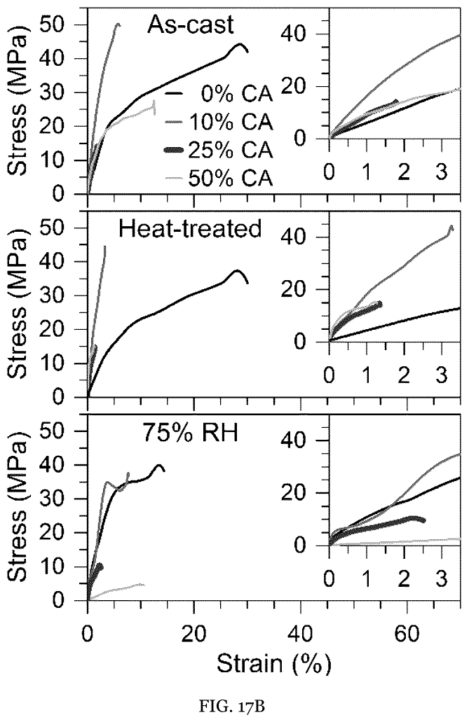

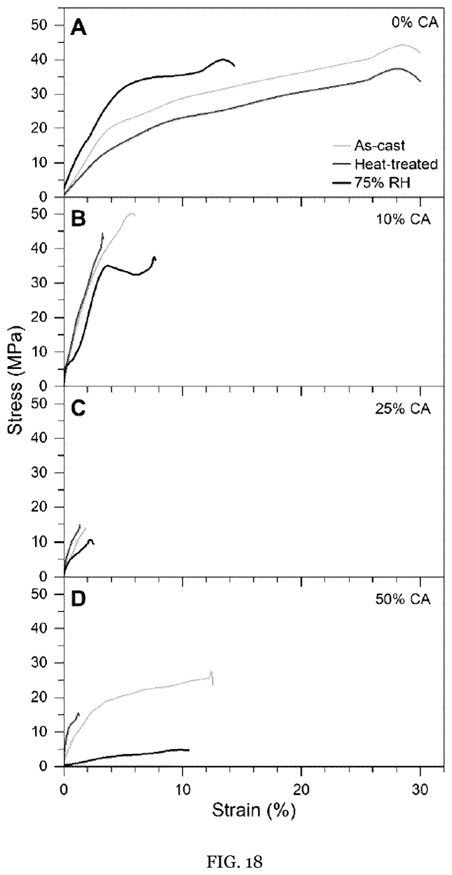

Collectively, our data shows that at 25 wt % CA content, i.e. 1 mol CA per 2.5 mol CMC monomer units, nearly complete crosslinking is reached, i.e. two out of three carboxylic acid groups react with CMC. At higher crosslinker content, some CA stays un- or partially reacted. As a result, a higher fraction of such films remains soluble when placed in deionized water compared to films to which the optimal CA amount was added (FIG. 17A, top panel, black markers). In contrast, the amount of material that remains soluble is around 20 wt % at a CA content of 10 wt % to 30 wt %.

The un- or partially reacted CA leads to other undesirable effects, including a high residual water content (RWC), extracted from the mass loss of dried films at 150° C. (FIG. 17A, bottom panel), which contributes to the increased WVTR observed in films with more than 25 wt % CA. While the difference between CMC/CA systems of 25 wt % and 50 wt % seems small (RWC content of 1 and 2 wt %), the implications are considerable. This is reflected in the mechanical behavior of CMC/CA foils. While as-cast films of a CA content of 50 wt % plastically deform, structures of optimal CA content (25 wt %) fail in the linear regime as a result of nearly complete to complete crosslinking (FIG. 17B, top panel). However, the total solubility of as-cast films in deionized water indicate that their crosslinks are not permanent, and thus non-covalent in nature (FIG. 17A, top panel, grey markers). After a heat-treatment at 120° C. for 2 hours, this picture changes as crosslinks become irreversible via esterification, leading the CMC/CA films to fail in the elastic regime independent of CA content (FIG. 17B, middle panel). Despite the fact that heat-treated films of 25 and 50 wt % CA are mechanically essentially identical, indicating similar degrees of crosslinking, the RWC of the latter remains about 1% higher than the former, pointing to the conclusion that un- or partially reacted CA is responsible for the greater affinity for water and higher WVTR in films of 50 wt % CA content. This view is corroborated by the mechanical response to changes in relative humidity, highlighted in the bottom panel of FIG. 17B, which is notably more pronounced in films of 50 wt % CA compared to 25 wt % CA, considering their increased breaking strain of approximately 500% and 100%, respectively. Clearly, there are substantial differences in the mechanical properties of crosslinked CMC compared to packaging plastics such as PET, which has an upper tensile strength and strain-at-break of 55 to 75 MPa and 65 to 320%, respectively. However, barrier packaging applications do not necessarily require the same performance. Thus, a compromise may eventually be sought to maximize strain at break, while minimizing the WVTR and residual water content. This possibly can be achieved in structures produced of alternating neat CMC and CMC/CA layers.

### Conclusion

In conclusion, we demonstrated that CA-crosslinked CMC displays excellent water barrier properties with a WVTR of less than 0.02 g mm per m² day (one order of magnitude less than PET) up to 65% RH. This example illustrates that the lowest attainable WVTR using crosslinked CMC is much less than inferred from similar studies, which have achieved only relatively small reductions in WVTR of approximately 0-60% compared to neat CMC, due to the addition of plasticizers or limitation to high testing humidities. In contrast, this example shows that the WVTR can be reduced by over 99.9% by crosslinking CMC with CA. The formation of ester crosslinks, which are conclusively identified by the 1718 cm⁻¹ vibration of NaOH-treated films, is critical to the barrier performance of the material. We highlight that it is important to precisely control the crosslink density. At too high CA content, unreacted and partially reacted crosslinker accumulates and leads to undesired water uptake/hydration and, in turn, an increase in WVTR.

### REFERENCES FOR EXAMPLE 2

1. Facts and Figures about Materials, Waste and Recycling, United States Environmental Protection Agency, 2022.
2. S. S. Ahankari, A. R. Subhedar, S. S. Bhadauria and A. Dufresne, Carbohydr. Polym., 2021, 255, 117479.
3. F. Silva, F. Dourado, M. Gama and F. Pocas, Nanomater., 2020, 10, 2041.
4. J. Vartiainen, P. Lahtinen, T. Kaljunen, V. Kunnari, M. S. Peresin and T. Tammelin O Papel., 2015, 76, 51-54.
5. S. Sharma, X. Zhang, S. S. Nair, A. Ragauskas, J. Zhu and Y. Deng, RSC Adv., 2014, 4, 45136-45142.
6. J. Wang, D. J. Gardner, N. M. Stark, D. W. Bousfield, M. Tajvidi and Z. Cai, ACS Sustain. Chem. Eng., 2017, 6, 49-70.
7. C. C. Satam, C. W. Irvin, A. W. Lang, J. C. R. Jallorina, M. L. Shofner, J. R. Reynolds, and J. C. Meredith, ACS Sustain. Chem. Eng., 2018, 6, 10637-10644.
8. G. Fotie, L. Amoroso, G. Muratore and L. Piergiovanni, Food Packag. Shelf Life, 2018, 18, 62-70.
9. M. Martínez-Sanz, A. Lopez-Rubio and J. M. Lagaron, Carbohydr. Polym., 2013, 98, 1072-1082.
10. C. Aulin, M. Gällstedt and T. Lindström, Cellulose, 2010, 17, 559-574.
11. I. Siró, D. Plackett, M. Hedenqvist, M. Ankerfors and T. Lindström, J. Appl. Polym. Sci., 2011, 119, 2652-2660.
12. J. Xia, Z. Zhang, W. Liu, V. C. F. Li, Y. Cao, W. Zhang and Y. Deng, Cellulose, 2018, 25, 4057-4066.
13. M. Shimizu, T. Saito and A. Isogai, J. Membr. Sci., 2016, 500, 1-7.
14. C. Chen, W. Sun, L. Wang, M. Tajvidi, J. Wang and D. J. Gardner, ACS Sustain. Chem. Eng., 2022, 10, 9419-9430.
15. Q. J. Chen, L. L. Zhou, J. Q. Zou and X. Gao, Int. J. Biol. Macromol., 2019, 132, 1155-1162.
16. M. A. Herrera, A. P. Mathew and K. Oksman, Cellulose, 2017, 24, 3969-3980.
17. V. Beghetto, V. Gatto, S. Conca, N. Bardella, C. Buranello, G. Gasparetto and R. Sole, Carbohydr. Polym., 2020, 249, 116810.
18. L. Zhuang, X. Zhi, B. Du and S. Yuan, ACS Omega, 2020, 5, 1086-1097.
19. P. G. Ponnusamy, J. Sundaram and S. Mani, J. Appl. Polym. Sci., 2021, 139, 52017.
20. T. Nongnual, N. Butprom, S. Boonsang, and S. Kaewpirom, Int. J. Biol. Macromol., 2024, 267, 131135.
21. H. Awada, D. Montplaisir and C. Daneault, Ind. Eng. Chem. Res., 2014, 53, 4312-4317.
22. A. Quellmalz and A. Mihranyan, ACS Biomater. Sci. Eng., 2015, 1, 271-276.
23. E. Rincon, L. Serrano, A. M. Balu, J. J. Aguilar, R. Luque and A. Garcia, Materials, 2019, 12, 2356.
24. A. A. Oun and J. W. Rhim, Carbohydr. Polym., 2015, 127, 101-109.
25. N. Zabihollahi, A. Alizadeh, H. Almasi, S. Hanifian and H. Hamishekar, Int. J. Biol. Macromol., 2020, 160, 409-417.
26. S. S. Nair, J. Zhu, Y. Deng and A. J. Ragauskas, Sustainable Chem. Processes, 2014, 2, 23.
27. G. de Souza, M. N. Belgacem, A. Gandini and A. J. F. Carvalho, Cellulose, 2021, 28, 1617-1632.
28. O. L. Sprockel, W. Prapaitrakul and P. Shivanand, J. Pharm. Pharmacol., 1990, 42, 152-157.
29. J. Lange and Y. Wyser, Packag. Technol. Sci., 2003, 16, 149-158.
30. L. K. Massey Film Properties of Plastics and Elastomers, William Andrew Publishing, 2004.
31. P. E. Keller and R. Kouzes, Water Vapor Permeation in Plastics, Pacific Northwest National Laboratory, 2016.
32. L. W. McKeen Permeability Properties of Plastics and Elastomers, Elsevier Science & Technology Books, 2011.
33. M. D. Steven and J. H. Hotchkiss, Packag. Technol. Sci., 2002, 15, 17-27.
34. R. Nisticò Polym. Test., 2020, 90, 106707.
35. K. M. Tavares, A. Campos, B. R. Luchesi, A. A. Resende, J. E. Oliveira and J. M. Marconcini, Carbohydr. Polym., 2020, 246, 116521.
36. Q. Yu, L. Yang, S. Wang, L. Zhang and D. Sun, Cellulose, 2023, 30, 10273-10284.

### Supplementary Data for Example 2

### Materials

Sodium carboxymethyl cellulose (CMC) with a degree of substitution of 1.2 and weight-average molecular weight of ˜250,000 g/mol was obtained from Sigma Aldrich. ACS reagent grade citric acid (CA) monohydrate (≥99.0% pure) was obtained from Sigma Aldrich.

### Methods

### Film Preparation

A parent CMC solution was prepared by dissolving 10.0 g CMC in 990.0 mL deionized water to yield a 1.0 wt % CMC solution. To prepare CMC films with different CA content, the appropriate amount of CA was dissolved in the CMC solution. CMC/CA mixtures were dried via drop casting in either polystyrene or Teflon dishes at ambient conditions. Dry films were peeled from the drying dish and prepared for characterization.

Heat-treated CMC/CA films were prepared by heating CMC/CA films in a convection oven at 120° C. for 2 hours to remove water and promote chemical reaction between CMC and CA.

### Fourier Transform Infrared Spectroscopy

Fourier transform infrared spectroscopy (FTIR) was measured using a Nicolet 6700 FTIR equipped with a diamond crystal attenuated total reflectance (ATR) attachment. The absorbance was measured from 400 to 4000 cm⁻¹ using 64 scans and a resolution of 4 cm⁻¹, and the resulting spectra were normalized by their maximum absorbance.

FTIR was measured for heat-treated CMC/CA films that were washed by soaking in an excess of deionized water to remove unreacted CA, and for heat-treated films that were treated with NaOH by soaking in NaOH solution with a pH of approximately 10. Additional NaOH was added as necessary to maintain the pH at approximately 10 until the films were completely deprotonated. The films were considered fully deprotonated when the pH of the NaOH solution was constant at approximately 10 after soaking overnight.

The least acidic proton in CMC/CA films is the third carboxylic acid group on CA (pKa3=6.4). At pH=10, all carboxylic acid groups on both CMC and CA are expected to be completely deprotonated since the pH is well above the pKa of the least acidic proton. Significant degradation of CMC is not expected at this pH. It was not possible to treat neat CMC films with NaOH since they are fully soluble in water. Thus, a solution with pH of approximately 7 was used to prepare the neat CMC film for FTIR.

### Water Vapor Transmission Rate

CMC/CA films were prepared by adding the appropriate amount of CA to 25.0 mL of 1.0 wt % CMC solution to yield films with 0, 10, 25, 30, 35, and 40% CA by mass. Film edges were cut away with scissors, and film thickness was measured using a micrometer and reported as the average of at least 10 measurements at different points on the film. Each film was masked using adhesive aluminum foil allowing for 1.0-5.0 cm² of exposed film area depending on the sample and test condition. If needed, the films were softened to facilitate cutting and masking by exposing to water vapor using an Electrotech ultrasonic humidification system. The masked films were heat-treated and stored in a desiccator equipped with saturated magnesium nitrate to maintain 53% RH for at least one day before testing.

Water vapor transmission rate (WVTR) was measured at 23° C. using a MOCON PERMATRAN-W 1/50 WVTR Analyzer. The dry side humidity was maintained at 5% RH while the wet side humidity was set to 50, 65, 70, 75, or 80% RH. The WVTR was normalized for the thickness of the films according to the equation below, where WVTR is the thickness-normalized WVTR (g-mm/m²-day), WVTRo is the absolute WVTR (g/m²-day), and t is the average film thickness (mm).

$$WVTR = {WVTR}_{0} \times t$$

### Soluble Fraction

To measure their soluble fraction, heat-treated CMC/CA films were stored under vacuum (<−0.09 MPa) at ambient temperature in a desiccator equipped with indicating drierite desiccant for at least 72 hours and the mass of the dry films was measured. The films were soaked in an excess of DI water (approximately 100 mL) for at least 72 hours. An initial mass of 0.05-0.2 g was used for all CMC/CA films. The films were removed from the water bath, dried under ambient conditions, and stored in a vacuum desiccator for at least 72 hours. The mass of each film was measured again, and the dissolved fraction was calculated according to the equation below, where m1 is the mass of the dry film before soaking in DI water, and m2 is the mass of the dry film after soaking in DI water.

$$Soluble fraction = \frac{{m}_{1} - {m}_{2}}{{m}_{1}} \times 100$$

### Residual Water Content

Residual water content was determined by calculating the mass loss of CMC/CA films when heated from 25 to 150° C. Mass loss was measured using a Mettler Toledo TGA/DSC 3+ STAR system at a heating rate of 20° C./min. Percent residual water content (RWC) was calculated according to the equation below, where m₂₅ and m₁₅₀ are the sample mass at 25° C. and 150° C., respectively.

$$RWC = \frac{{m}_{25} - {m}_{150}}{{m}_{25}} \times 100$$

### Mechanical Properties

Mechanical properties (upper tensile strength, strain at break, and Young's modulus) were measured using a high-throughput mechanical characterization (HTMECH) instrument. In short, CMC/CA and CMC/CA/HT films were sandwiched between two perforated plates. The samples were punctured by a blunt needle through the perforated plates at different locations on the film. The force, displacement, and contact time were used to calculate stress/strain behavior of the films. Measurements were repeated at least 8 times per sample.

TABLE 3
Water vapor transmission rates (WVTR) of films at different
experimental conditions and with different curing times (T_{c})

| | T_{c} | RH | T | WVTR |
|---|---|---|---|---|
| Material | ° C. | % | ° C. | g-mm/m²-day |
| CMC | 120 | 50 | 23 | 25.5 |
| CMC/CA10 | 120 | 50 | 23 | 1.5 |
| CMC/CA25 | 120 | 65 | 23 | 0.02 |
| CMC | 60 | 50 | 14 | 47.9 |
| | 40 | 50 | 25 | 192 |
| | N/A | 97 | 25 | 381 |
| Cellulose nanofibril | N/A | 50 | — | 9.8 |
| | N/A | 50 | 23 | 22 |
| | 175 | 100 | 40 | 203 |
| | N/A | 50 | 23 | 7 |
| | 145 | 50 | 23 | 0.16 |
| | 170 | 50 | 23 | 1.7 |
| Cellulose nanofibril/chitosan/CA | N/A | 50 | 23 | 24.3 |
| Cellulose acetate | N/A | 50 | 20 | ~10.4 |
| | N/A | 90 | 20 | 22.12 |
| Cellulose butyrate | N/A | 50 | 20 | ~1.1 |
| | N/A | 90 | 20 | 17.97 |
| Cellulose propionate | N/A | 50 | 20 | ~6.9 |
| | N/A | 90 | 20 | 21.54 |
| Poly(ethylene terephthalate) | N/A | 50 | 23 | 0.16 |
| | N/A | 85 | 23 | 0.5-2 |
| | N/A | — | — | 1.2 |
| | N/A | 90 | 38 | 0.4-8 |
| | N/A | — | — | 0.79 |
| High density polyethylene | N/A | — | 25 | 0.0148 |
| | N/A | 90 | 38 | |
| Low density polyethylene | N/A | — | 25 | 0.112 |
| | N/A | 100 | 38 | 0.589-0.766 |
| Polypropylene | N/A | 85 | 23 | 0.2-0.4 |
| | N/A | 90 | 38 | 0.7-2 |
| Poly(vinyl chloride) | N/A | — | 25 | 0.451 |
| | N/A | 90 | 38 | <1.6 |
| | N/A | 85 | 23 | 1-2 |
| Poly(vinylidene chloride) | N/A | — | — | 0.024-0.913 |
| | N/A | — | — | 0.065 |
| | N/A | 85 | 23 | 0.1 |
| | N/A | 90 | 38 | 1.7 |
| | N/A | 100 | 27 | 0.04 |
| | N/A | — | — | 0.11 |

Values marked in bold and italic above were determined in this example.

TABLE 4
Tensile strength (TS), strain at break (SAB), and Young's
modulus (YM) of CMC/CA films before and after heat-
treatment. Values represent the average and standard
deviation (σ) of at least eight measurements.

| CA | | | | | | | |
|---|---|---|---|---|---|---|---|
| content | Sample | TS | | SAB | | YM | |
| (wt %) | set | (MPa) | σ_{TS} | (%) | σ_{SAB} | (GPa) | σ_{YM} |
| 0 | As-cast | 39.7 | 3.2 | 27.7 | 4.6 | 0.6 | 0.1 |
| 0 | Heat- | 38.6 | 3.0 | 56.7 | 13.3 | 0.2 | 0.2 |
| | treated | | | | | | |
| 0 | 75% RH | 38.0 | 2.1 | 18.2 | 2.6 | 0.7 | 0.2 |
| 10 | As-cast | 49.8 | 2.4 | 7.5 | 1.7 | 1.9 | 0.4 |
| 10 | Heat- | 36.8 | 11.2 | 2.8 | 1.0 | 2.7 | 0.7 |
| | treated | | | | | | |
| 10 | 75% RH | 33.0 | 3.4 | 7.9 | 1.3 | 0.7 | 0.3 |
| 25 | As-cast | 25.6 | 15.4 | 4.6 | 4.1 | 8.1 | 5.7 |
| 25 | Heat- | 11.3 | 1.3 | 1.3 | 0.7 | 2.8 | 1.7 |
| | treated | | | | | | |
| 25 | 75% RH | 10.3 | 1.9 | 5.1 | 0.9 | 0.7 | 0.4 |
| 50 | As-cast | 25.0 | 3.0 | 11.7 | 4.9 | 0.7 | 0.3 |
| 50 | Heat- | 11.6 | 3.4 | 1.6 | 0.8 | 3.4 | 1.5 |
| | treated | | | | | | |
| 50 | 75% RH | 4.6 | 0.5 | 3.2 | 1.2 | 0.1 | 0.02 |

### REFERENCES FOR SUPPLEMENTARY DATA FOR EXAMPLE 2

1. C. Demitri, R. Del Sole, F. Scalera, A. Sannino, G. Vasapollo, A. Maffezzoli, L. Ambrosio and L. Nicolais, Journal of Applied Polymer Science, 2008, 110, 2453-2460.
2. L. Zhuang, X. Zhi, B. Du and S. Yuan, ACS Omega, 2020, 5, 1086-1097.
3. N. Reddy and Y. Yang, Food Chemistry, 2010, 118, 702-711.
4. R. Ciriminna, F. Meneguzzo, R. Delisi and M. Pagliaro, Chem Cent J, 2017, 11, 22.
5. A. Martínez, R. Vargas and A. Galano, Computational and Theoretical Chemistry, 2018, 1133, 47-50.
6. R. N. Goldberg, N. Kishore and R. M. Lennen, Journal of Physical and Chemical Reference Data, 2002, 31, 231-370.
7. A. M. Zhivkov, in Cellulose: Fundamental Aspects, eds. T. v. d. Ven and L. Godbout, 2013.
8. B. K. Baral, R. S. Singhal and P. R. Kulkarni, Carbohydr Polym, 1997, 32, 229-231.
9. M. P. Adinugraha, D. W. Marseno and Haryadi, Carbohydrate Polymers, 2005, 62, 164-169.
10. P. Rachtanapun and N. Rattanapanone, Journal of Applied Polymer Science, 2011, 122, 3218-3226.
11. J.-L. Sormana, S. Chattopadhyay and J. Carson Meredith, Review of Scientific Instruments, 2005, 76.
12. E. Rincon, L. Serrano, A. M. Balu, J. J. Aguilar, R. Luque and A. Garcia, Materials (Basel), 2019, 12.
13. A. A. Oun and J. W. Rhim, Carbohydr Polym, 2015, 127, 101-109.
14. N. Zabihollahi, A. Alizadeh, H. Almasi, S. Hanifian and H. Hamishekar, Int J Biol Macromol, 2020, 160, 409-417.
15. S. S. Nair, J. Zhu, Y. Deng and A. J. Ragauskas, Sustainable Chemical Processes, 2014, 2.
16. J. Vartiainen, P. Lahtinen, T. Kaljunen, V. Kunnari, M. S. Peresin and T. Tammelin, O Pap, 2015, 76, 51-54.
17. S. Sharma, X. Zhang, S. S. Nair, A. Ragauskas, J. Zhu and Y. Deng, RSC Adv., 2014, 4, 45136-45142.
18. G. de Souza, M. N. Belgacem, A. Gandini and A. J. F. Carvalho, Cellulose, 2021.
19. J. Xia, Z. Zhang, W. Liu, V. C. F. Li, Y. Cao, W. Zhang and Y. Deng, Cellulose, 2018, 25, 4057-4066.
20. P. G. Ponnusamy, J. Sundaram and S. Mani, Journal of Applied Polymer Science, 2021.
21. O. L. Sprockel, W. Prapaitrakul and P. Shivanand, Journal of Pharmacy and Pharmacology, 1990, 42, 152-157.
22. J. Lange and Y. Wyser, Packaging Technology and Science, 2003, 16, 149-158.
23. L. K. Massey, Film Properties of Plastics and Elastomers, William Andrew Publishing, Second Edition edn., 2004.
24. J. Wang, D. J. Gardner, N. M. Stark, D. W. Bousfield, M. Tajvidi and Z. Cai, ACS Sustainable Chemistry & Engineering, 2017, 6, 49-70.
25. P. E. Keller and R. Kouzes, Water Vapor Permeation in Plastics, Pacific Northwest National Laboratory, 2016.
26. L. W. McKeen, Permeability Properties of Plastics and Elastomers, Elsevier Science & Technology Books, 2011.
27. M. D. Steven and J. H. Hotchkiss, Packaging Technology and Science, 2002, 15, 17-27.

### FURTHER REFERENCES OF EXPERIMENTAL EXAMPLES

1. Adin, D. et al. Strategy for Plastics Innovation. (U.S. Department of Energy, 2023).
2. The New Plastics Economy: Rethinking the future of plastics. (Ellen MacArthur Foundation and Mckinsey & Company, World Economic Forum, 2016).
3. Hasanzadeh, R. & Mojaver, P. Plastic Waste Treatment and Management. 1 edn, (Springer Cham, 2023).
4. Geyer, R., Jambeck, J. R. & Law, K. L. Production, use, and fate of all plastics ever made. Science Advances 3 (2017).
5. McKeen, L. W. Permeability Properties of Plastics and Elastomers. Fourth edn, (Matthew Deans, 2017).
6. Li, F., Mascheroni, E. & Piergiovanni, L. The Potential of NanoCellulose in the Packaging Field: A Review. Packaging Technology and Science 28, 475-508 (2015).
7. Moon, R. J., Martini, A., Nairn, J., Simonsen, J. & Youngblood, J. Cellulose nanomaterials review: structure, properties and nanocomposites. Chem Soc Rev 40, 3941-3994 (2011).
8. Lee, H. & Mani, S. Mechanical pretreatment of cellulose pulp to produce cellulose nanofibrils using a dry grinding method. Industrial Crops and Products 104, 179-187 (2017).
9. Chen, J. H. et al. Preparation and properties of microfibrillated cellulose with different carboxyethyl content. Carbohydr Polym 206, 616-624 (2019).
10. Dong, X. M., Revol, J.-F. & Gray, D. G. Effect of microcrystallite preparation conditions on the formation of colloid crystals of cellulose. Cellulose 5, 19-32 (1998).
11. Chowdhury, R. A. et al. Cellulose Nanocrystal (CNC) Coatings with Controlled Anisotropy as High-Performance Gas Barrier Films. ACS Appl Mater Interfaces 11, 1376-1383 (2019).
12. Thakur, V., Guleria, A., Kumar, S., Sharma, S. & Singh, K. Recent advances in nanocellulose processing, functionalization and applications: a review. Materials Advances 2, 1872-1895 (2021).
13. Salimi, S., Sotudeh-Gharebagh, R., Zarghami, R., Chan, S. Y. & Yuen, K. H. Production of Nanocellulose and Its Applications in Drug Delivery: A Critical Review. ACS Sustainable Chemistry & Engineering 7, 15800-15827 (2019).
14. Abouzeid, R. E., Khiari, R., El-Wakil, N. & Dufresne, A. Current State and New Trends in the Use of Cellulose Nanomaterials for Wastewater Treatment. Biomacromolecules 20, 573-597 (2019).
15. Isogai, A. & Kato, Y. Preparation of polyuronic acid from cellulose by TEMPO-mediated oxidation. Cellulose 5, 153-164 (1998).
16. Kato, Y., Kaminaga, J.-i., Matsuo, R. & Isogai, A. Oxygen Permeability and Biodegradability of Polyuronic Acids Prepared from Polysaccharides by TEMPO-Mediated Oxidation. Journal of Polymers and the Environment 13, 261-266 (2005).
17. Hollabaugh, C. B., Burt, L. H. & Walsh, A. P. Carboxymethylcellulose: Uses and Applications. Industrial & Engineering Chemistry 37, 943-947 (1945).
18. Heinze, T., Seoud, O. A. E. & Koschella, A. Cellulose Derivatives. 1 edn, (Springer Cham, 2018).
19. Dürig, T. & Karan, K. in Handbook of Pharmaceutical Wet Granulation 317-349 (2019).
20. Shamshina, J. L., Berton, P. & Rogers, R. D. Advances in Functional Chitin Materials: A Review. ACS Sustainable Chemistry & Engineering 7, 6444-6457 (2019).
21. Wu, J., Zhang, K., Girouard, N. & Meredith, J. C. Facile route to produce chitin nanofibers as precursors for flexible and transparent gas barrier materials. Biomacromolecules 15, 4614-4620 (2014).
22. Salaberria, A. M., Diaz, R. H., Labidi, J. & Fernandes, S. C. M. Role of chitin nanocrystals and nanofibers on physical, mechanical and functional properties in thermoplastic starch films. Food Hydrocolloids 46, 93-102 (2015).
23. Bai, L. et al. Nanochitin: Chemistry, Structure, Assembly, and Applications. Chem Rev 122, 11604-11674 (2022).
24. Satam, C. C. et al. Controlling Barrier and Mechanical Properties of Cellulose Nanocrystals by Blending with Chitin Nanofibers. Biomacromolecules 21, 545-555 (2020).
25. Ji, Y. et al. Minimizing Oxygen Permeability in Chitin/Cellulose Nanomaterial Coatings by Tuning Chitin Deacetylation. ACS Sustainable Chemistry & Engineering 10, 124-133 (2021).
26. Ahankari, S. S., Subhedar, A. R., Bhadauria, S. S. & Dufresne, A. Nanocellulose in food packaging: A review. Carbohydr Polym 255, 117479 (2021).
27. Silva, F., Dourado, F., Gama, M. & Pocas, F. Nanocellulose Bio-Based Composites for Food Packaging. Nanomaterials (Basel) 10 (2020).
28. Vartiainen, J. et al. Comparison of properties between cellulose nanofibrils made from banana, sugar beet, hemp, softwood and hardwood pulps. O Pap 76, 51-54 (2015).
29. Sharma, S. et al. Thermally enhanced high performance cellulose nano fibril barrier membranes. RSC Adv. 4, 45136-45142 (2014).
30. Wang, J. et al. Moisture and Oxygen Barrier Properties of Cellulose Nanomaterial-Based Films. ACS Sustainable Chemistry & Engineering 6, 49-70 (2017).
31. Satam, C. C. et al. Spray-Coated Multilayer Cellulose Nanocrystal—Chitin Nanofiber Films for Barrier Applications. ACS Sustainable Chemistry & Engineering 6, 10637-10644 (2018).
32. Fotie, G., Amoroso, L., Muratore, G. & Piergiovanni, L. Carbon dioxide diffusion at different relative humidity through coating of cellulose nanocrystals for food packaging applications. Food Packaging and Shelf Life 18, 62-70 (2018).
33. Martínez-Sanz, M., Lopez-Rubio, A. & Lagaron, J. M. High-barrier coated bacterial cellulose nanowhiskers films with reduced moisture sensitivity. Carbohydrate Polymers 98, 1072-1082 (2013).
34. Aulin, C., Gällstedt, M. & Lindström, T. Oxygen and oil barrier properties of microfibrillated cellulose films and coatings. Cellulose 17, 559-574 (2010).
35. Siró, I., Plackett, D., Hedenqvist, M., Ankerfors, M. & Lindström, T. Highly transparent films from carboxymethylated microfibrillated cellulose: The effect of multiple homogenization steps on key properties. Journal of Applied Polymer Science 119, 2652-2660 (2011).
36. Minelli, M. et al. Investigation of mass transport properties of microfibrillated cellulose (MFC) films. Journal of Membrane Science 358, 67-75 (2010).
37. Bedane, A. H., Eić, M., Farmahini-Farahani, M. & Xiao, H. Water vapor transport properties of regenerated cellulose and nanofibrillated cellulose films. Journal of Membrane Science 493, 46-57 (2015).
38. Keller, P. E. & Kouzes, R. Water Vapor Permeation in Plastics. (Pacific Northwest National Laboratory, 2016).
39. McKeen, L. W. Permeability Properties of Plastics and Elastomers. (Elsevier Science & Technology Books, 2011).
40. Nair, S. S., Zhu, J., Deng, Y. & Ragauskas, A. J. High performance green barriers based on nanocellulose. Sustainable Chemical Processes 2 (2014).
41. Rodionova, G., Lenes, M., Eriksen, Ø. & Gregersen, Ø. Surface chemical modification of microfibrillated cellulose: improvement of barrier properties for packaging applications. Cellulose 18, 127-134 (2010).
42. Costa, V. L. D. & Simões, R. M. S. Hydrophobicity improvement of cellulose nanofibrils films by stearic acid and modified precipitated calcium carbonate coating. Journal of Materials Science 57, 11443-11459 (2022).
43. Du, P. et al. The fluorine-free coating has excellent hydrophobic and oleophobic properties for porous cellulose-based materials. Cellulose 28, 6133-6146 (2021).
44. Djafari Petroudy, S. R., Rahmani, N., Rasooly Garmaroody, E., Rudi, H. & Ramezani, O. Comparative study of cellulose and lignocellulose nanopapers prepared from hard wood pulps: Morphological, structural and barrier properties. Int J Biol Macromol 135, 512-520 (2019).
45. Scatolino, M. V., Bufalino, L., Mendes, L. M., Guimarães Júnior, M. & Tonoli, G. H. D. Impact of nanofibrillation degree of eucalyptus and Amazonian hardwood sawdust on physical properties of cellulose nanofibril films. Wood Science and Technology 51, 1095-1115 (2017).
46. Rincon, E. et al. Effect of Bay Leaves Essential Oil Concentration on the Properties of Biodegradable Carboxymethyl Cellulose-Based Edible Films. Materials (Basel) 12 (2019).
47. Oun, A. A. & Rhim, J. W. Preparation of multifunctional carboxymethyl cellulose-based films incorporated with chitin nanocrystal and grapefruit seed extract. Int J Biol Macromol 152, 1038-1046 (2020).
48. Oun, A. A. & Rhim, J. W. Preparation and characterization of sodium carboxymethyl cellulose/cotton linter cellulose nanofibril composite films. Carbohydr Polym 127, 101-109 (2015).
49. Oun, A. A. & Rhim, J. W. Effect of oxidized chitin nanocrystals isolated by ammonium persulfate method on the properties of carboxymethyl cellulose-based films. Carbohydr Polym 175, 712-720 (2017).
50. Ebrahimzadeh, S., Ghanbarzadeh, B. & Hamishehkar, H. Physical properties of carboxymethyl cellulose based nano-biocomposites with Graphene nano-platelets. Int J Biol Macromol 84, 16-23 (2016).
51. Sprockel, O. L., Prapaitrakul, W. & Shivanand, P. Permeability of Cellulose Polymers: Water Vapour Transmission Rates. Journal of Pharmacy and Pharmacology 42, 152-157 (1990).
52. Cazon, P., Vazquez, M. & Velazquez, G. Regenerated cellulose films with chitosan and polyvinyl alcohol: Effect of the moisture content on the barrier, mechanical and optical properties. Carbohydr Polym 236, 116031 (2020).
53. Shanmugam, K. et al. High-performance homogenized and spray coated nanofibrillated cellulose-montmorillonite barriers. Cellulose 28, 405-416 (2020).
54. Aulin, C., Salazar-Alvarez, G. & Lindstrom, T. High strength, flexible and transparent nanofibrillated cellulose-nanoclay biohybrid films with tunable oxygen and water vapor permeability. Nanoscale 4, 6622-6628 (2012).
55. de Melo Fiori, A. P. S., Camani, P. H., dos Santos Rosa, D. & Carastan, D. J. Combined effects of clay minerals and polyethylene glycol in the mechanical and water barrier properties of carboxymethylcellulose films. Industrial Crops and Products 140 (2019).
56. Quilaqueo Gutiérrez, M., Echeverría, I., Ihl, M., Bifani, V. & Mauri, A. N. Carboxymethylcellulose—montmorillonite nanocomposite films activated with murta (Ugni molinae Turcz) leaves extract. Carbohydrate Polymers 87, 1495-1502 (2012).
57. Fathi Achachlouei, B. & Zahedi, Y. Fabrication and characterization of CMC-based nanocomposites reinforced with sodium montmorillonite and TiO(2) nanomaterials. Carbohydr Polym 199, 415-425 (2018).
58. Zahedi, Y., Fathi-Achachlouei, B. & Yousefi, A. R. Physical and mechanical properties of hybrid montmorillonite/zinc oxide reinforced carboxymethyl cellulose nanocomposites. Int J Biol Macromol 108, 863-873 (2018).
59. Oliveira, R. L. d. et al. Transparent organic-inorganic nanocomposites membranes based on carboxymethylcellulose and synthetic clay. Industrial Crops and Products 69, 415-423 (2015).
60. Bardet, R. et al. Substitution of nanoclay in high gas barrier films of cellulose nanofibrils with cellulose nanocrystals and thermal treatment. Cellulose 22, 1227-1241 (2015).
61. Garusinghe, U. M., Varanasi, S., Raghuwanshi, V. S., Garnier, G. & Batchelor, W. Nanocellulose-montmorillonite composites of low water vapour permeability. Colloids and Surfaces A: Physicochemical and Engineering Aspects 540, 233-241 (2018).
62. Ebrahimi, Y., Peighambardoust, S. J., Peighambardoust, S. H. & Karkaj, S. Z. Development of Antibacterial Carboxymethyl Cellulose-Based Nanobiocomposite Films Containing Various Metallic Nanoparticles for Food Packaging Applications. J Food Sci 84, 2537-2548 (2019).
63. Roy, S. & Rhim, J. W. Carboxymethyl cellulose-based antioxidant and antimicrobial active packaging film incorporated with curcumin and zinc oxide. Int J Biol Macromol 148, 666-676 (2020).
64. Wu, D., Chang, P. R. & Ma, X. Preparation and properties of layered double hydroxide-carboxymethylcellulose sodium/glycerol plasticized starch nanocomposites. Carbohydrate Polymers 86, 877-882 (2011).
65. Wu, H., Thibault, J. & Kruczek, B. The validity of the time-lag method for the characterization of mixed-matrix membranes. Journal of Membrane Science 618 (2021).
66. Wijmans, J. G. & Baker, R. W. The solution-diffusion model: a review. Journal of Membrane Science 107, 1-21 (1995).
67. Ghosal, K. & Freeman, B. D. Gas separation using polymer membranes: an overview. Polymers for Advanced Technologies 5, 673-697 (2003).
68. Lagaron, J. M., Catalá, R. & Gavara, R. Structural characteristics defining high barrier properties in polymeric materials. Materials Science and Technology 20, 1-7 (2013).
69. Felder, R. M. & Huvard, G. S. in Methods in Experimental Physics Vol. 16 Methods in Experimental Physics (ed R. A. Fava) Ch. 17, 315-377 (1980).
70. Materials Science of Membranes for Gas and Vapor Separation. (John Wiley & Sons, Ltd., 2006).
71. Gusev, A. A., Müller-Plathe, F., Gunsteren, W. F. v. & Suter, U. W. in Atomistic Modeling of Physical Properties Vol. 116 Advances in Polymer Science 207-247 (Springer, Berlin, Heidelberg, 1994).
72. Marais, S. et al. Permeation of water through polar and nonpolar polymers and copolymers: Determination of the concentration-dependent diffusion coefficient. Journal of Polymer Science Part B: Polymer Physics 38, 1998-2008 (2000).
73. Nuruddin, M. et al. Influence of Free Volume Determined by Positron Annihilation Lifetime Spectroscopy (PALS) on Gas Permeability of Cellulose Nanocrystal Films. ACS Appl Mater Interfaces 12, 24380-24389 (2020).
74. Mazeau, K. & Heux, L. Molecular Dynamics Simulations of Bulk Native Crystalline and Amorphous Structures of Cellulose. J. Phys. Chem. B 107, 2394-2403 (2003).
75. Wolstenholme, W. E. Correlation of physical and polymer chain properties. Polymer Engineering & Science 8, 142-150 (2004).
76. Wiles, J. L. The effect of relative humidity on the steady state water vapor permeability of chitosan films PhD thesis, Clemson University, (2000).
77. Azeredo, H. M. C. & Waldron, K. W. Crosslinking in polysaccharide and protein films and coatings for food contact—A review. Trends in Food Science & Technology 52, 109-122 (2016).
78. Lee, K. et al. Double-crosslinked cellulose nanofiber based bioplastic films for practical applications. Carbohydr Polym 260, 117817 (2021).
79. Gan, P. G., Sam, S. T., Abdullah, M. F., Omar, M. F. & Tan, W. K. Comparative study on the properties of cross-linked cellulose nanocrystals/chitosan film composites with conventional heating and microwave curing. Journal of Applied Polymer Science 137 (2020).
80. Xia, J. et al. Highly transparent 100% cellulose nanofibril films with extremely high oxygen barriers in high relative humidity. Cellulose 25, 4057-4066 (2018).
81. Shimizu, M., Saito, T. & Isogai, A. Water-resistant and high oxygen-barrier nanocellulose films with interfibrillar cross-linkages formed through multivalent metal ions. Journal of Membrane Science 500, 1-7 (2016).
82. Chen, C. et al. Transparent Multifunctional Cellulose Nanocrystal Films Prepared Using Trivalent Metal Ion Exchange for Food Packaging. ACS Sustainable Chemistry & Engineering 10, 9419-9430 (2022).
83. Zhang, K., Ismail, M. Y. & Liimatainen, H. Water-resistant nanopaper with tunable water barrier and mechanical properties from assembled complexes of oppositely charged cellulosic nanomaterials. Food Hydrocolloids 120 (2021).
84. Pasquier, E. et al. Multilayers of Renewable Nanostructured Materials with High Oxygen and Water Vapor Barriers for Food Packaging. ACS Applied Materials & Interfaces 14, 30236-30245 (2022).
85. de Souza, G., Belgacem, M. N., Gandini, A. & Carvalho, A. J. F. Low permeable hydrophobic nanofibrilated cellulose films modified by dipping and heating processing technique. Cellulose (2021).
86. Lu, P., Xiao, H., Zhang, W. & Gong, G. Reactive coating of soybean oil-based polymer on nanofibrillated cellulose film for water vapor barrier packaging. Carbohydr Polym 111, 524-529 (2014).
87. Li, W., Wang, S., Wang, W., Qin, C. & Wu, M. Facile preparation of reactive hydrophobic cellulose nanofibril film for reducing water vapor permeability (WVP) in packaging applications. Cellulose 26, 3271-3284 (2019).
88. Huang, Y. et al. Hydrophobic modification of chitin whisker and its potential application in structuring oil. Langmuir 31, 1641-1648 (2015).
89. Li, F., Liu, W. G. & Yao, K. D. Preparation of oxidized glucose-crosslinked N-alkylated chitosan membrane and in vitro studies of pH-sensitive drug delivery behavior. Biomaterials 23, 343-347 (2002).
90. Cunha, A. G. & Gandini, A. Turning polysaccharides into hydrophobic materials: a critical review. Part 2. Hemicelluloses, chitin/chitosan, starch, pectin and alginates. Cellulose 17, 1045-1065 (2010).
91. Facts and Figures about Materials, Waste and Recycling. United States Environmental Protection Agency (2021).
92. National Overview: Facts and Figures on Materials, Wastes and Recycling. United States Environmental Protection Agency (2022).
93. Chen, Q. J., Zhou, L. L., Zou, J. Q. & Gao, X. The preparation and characterization of nanocomposite film reinforced by modified cellulose nanocrystals. Int J Biol Macromol 132, 1155-1162 (2019).
94. Nongnual, T., Butprom, N., Boonsang, S. & Kaewpirom, S. Citric acid crosslinked carboxymethyl cellulose edible films: A case study on preserving freshness in bananas. Int J Biol Macromol 267, 131135 (2024).
95. Beghetto, V. et al. Development of 4-(4,6-dimethoxy-1,3,5-triazin-2-yl)-4-methyl-morpholinium chloride cross-linked carboxymethyl cellulose films. Carbohydr Polym 249, 116810 (2020).
96. Tavares, K. M. et al. Effect of carboxymethyl cellulose concentration on mechanical and water vapor barrier properties of corn starch films. Carbohydr Polym 246, 116521 (2020).
97. Martínez, A., Vargas, R. & Galano, A. Citric acid: A promising copper scavenger. Computational and Theoretical Chemistry 1133, 47-50 (2018).
98. Goldberg, R. N., Kishore, N. & Lennen, R. M. Thermodynamic Quantities for the Ionization Reactions of Buffers. Journal of Physical and Chemical Reference Data 31, 231-370 (2002).
99. Baral, B. K., Singhal, R. S. & Kulkarni, P. R. Optimization of a process for preparing carboxymethyl cellulose from water hyacinth (Eichhornia crassipes). Carbohydr Polym 32, 229-231 (1997).
100. Adinugraha, M. P., Marseno, D. W. & Haryadi. Synthesis and characterization of sodium carboxymethylcellulose from cavendish banana pseudo stem (Musa cavendishii LAMBERT). Carbohydrate Polymers 62, 164-169 (2005).
101. Rachtanapun, P. & Rattanapanone, N. Synthesis and characterization of carboxymethyl cellulose powder and films from Mimosa pigra. Journal of Applied Polymer Science 122, 3218-3226 (2011).
102. Reviakine, I., Morozov, A. N. & Rossetti, F. F. Effects of finite crystal size in the quartz crystal microbalance with dissipation measurement system: Implications for data analysis. Journal of Applied Physics 95, 7712-7716 (2004).
103. Sormana, J.-L., Chattopadhyay, S. & Carson Meredith, J. High-throughput mechanical characterization of free-standing polymer films. Review of Scientific Instruments 76 (2005).
104. Lazar, S. et al. Crosslinkable-Chitosan-Enabled Moisture-Resistant Multilayer Gas Barrier Thin Film. Macromol Rapid Commun 40, e1800853 (2019).
105. Yang, W. et al. High wet-strength, thermally stable and transparent TEMPO-oxidized cellulose nanofibril film via cross-linking with poly-amide epichlorohydrin resin. RSC Advances 7, 31567-31573 (2017).
106. Quellmalz, A. & Mihranyan, A. Citric Acid Cross-Linked Nanocellulose-Based Paper for Size-Exclusion Nanofiltration. ACS Biomater Sci Eng 1, 271-276 (2015).
107. Demitri, C. et al. Novel superabsorbent cellulose-based hydrogels crosslinked with citric acid. Journal of Applied Polymer Science 110, 2453-2460 (2008).
108. Awada, H., Montplaisir, D. & Daneault, C. Cross-Linking of Papers Based on Thermomechanical Pulp Fibers by Polycarboxylic Acids: Influence on the Wet Breaking Length. Industrial & Engineering Chemistry Research 53, 4312-4317 (2014).
109. Reddy, N. & Yang, Y. Citric acid cross-linking of starch films. Food Chemistry 118, 702-711 (2010).
110. Ponnusamy, P. G., Sundaram, J. & Mani, S. Preparation and characterization of citric acid crosslinked chitosan-cellulose nanofibrils composite films for packaging applications. Journal of Applied Polymer Science (2021).
111. Zhuang, L., Zhi, X., Du, B. & Yuan, S. Preparation of Elastic and Antibacterial Chitosan-Citric Membranes with High Oxygen Barrier Ability by in Situ Cross-Linking. ACS Omega 5, 1086-1097 (2020).
112. Herrera, M. A., Mathew, A. P. & Oksman, K. Barrier and mechanical properties of plasticized and cross-linked nanocellulose coatings for paper packaging applications. Cellulose 24, 3969-3980 (2017).
113. Ghosh Dastidar, T. & Netravali, A. N. ‘Green’ crosslinking of native starches with malonic acid and their properties. Carbohydr Polym 90, 1620-1628 (2012).
114. Menzel, C. et al. Molecular structure of citric acid cross-linked starch films. Carbohydr Polym 96, 270-276 (2013).
115. Olsson, E. et al. The effect of pH on hydrolysis, cross-linking and barrier properties of starch barriers containing citric acid. Carbohydr Polym 98, 1505-1513 (2013).
116. Apelblat, A. in Citric Acid Ch. 2, 13-141 (2014).
117. Russo, M., Rigby, S. E. J., Caseri, W. & Stingelin, N. Pronounced photochromism of titanium oxide hydrates (hydrous TiO2). J. Mater. Chem. 20, 1348-1356 (2010).
118. Russo, M. et al. One-pot synthesis of polymer/inorganic hybrids: toward readily accessible, low-loss, and highly tunable refractive index materials and patterns. Journal of Polymer Science Part B: Polymer Physics 50, 65-74 (2012).
119. Paradies, J. et al. Photogeneration of titanium(III) from titanium(IV) citrate in aqueous solution. J Inorg Biochem 100, 1260-1264 (2006).
120. Russo, M., Rigby, S. E., Caseri, W. & Stingelin, N. Versatile chromism of titanium oxide hydrate/poly(vinyl alcohol) hybrid systems. Adv Mater 24, 3015-3019 (2012).
121. Einaga, H. & Komatsu, Y. Hydrolytic precipitation reaction of titanium(IV) from (Na, H) Cl aqueous solution. Journal of Inorganic and Nuclear Chemistry 43, 2443-2448 (1981).
122. Uppal, R., Incarvito, C. D., Lakshmi, K. V. & Valentine, A. M. Aqueous Spectroscopy and Redox Properties of Carboxylate-Bound Titanium. Inorganic Chemistry 45, 1795-1804 (2006).
123. Deng, Y.-F. et al. Titanium-based mixed oxides from a series of titanium(IV) citrate complexes. Journal of Solid State Chemistry 180, 3152-3159 (2007).
124. Kefalas, E. T. et al. Mononuclear Titanium(IV)-Citrate Complexes from Aqueous Solutions: pH-Specific Synthesis and Structural and Spectroscopic Studies in Relevance to Aqueous Titanium(IV)-Citrate Speciation. Inorganic Chemistry 44, 2596-2605 (2005).
125. Collins, J. M., Uppal, R., Incarvito, C. D. & Valentine, A. M. Titanium(IV) Citrate Speciation and Structure under Environmentally and Biologically Relevant Conditions. Inorganic Chemistry 44, 3431-3440 (2005).
126. Durbin, M. M. Structure-property relationships for mixed ion- and electron-conducting polymer systems Doctor of Philosophy thesis, Georgia Institute of Technology, (2023).
127. Larsen, A. O., White, P. S. & Gagné, M. R. Acid-Base Adducts of Catalytically Active Titanium(IV) Lewis Acids. Inorganic Chemistry 38 (1999).
128. Shi, M., Jiang, J.-K. & Cui, S.-C. Titanium(IV) chloride and oxy-compounds promoted Baylis-Hillman reaction. Tetrahedron 57, 7343-7347 (2001).
129. Livage, J., Henry, M. & Sanchez, C. Sol-gel chemistry of transition metal oxides. Progress in Solid State Chemistry 18, 259-341 (1988).
130. Tong, Q., Xiao, Q. & Lim, L.-T. Preparation and properties of pullulan-alginate-carboxymethylcellulose blend films. Food Research International 41, 1007-1014 (2008).
131. Zabihollahi, N., Alizadeh, A., Almasi, H., Hanifian, S. & Hamishekar, H. Development and characterization of carboxymethyl cellulose based probiotic nanocomposite film containing cellulose nanofiber and inulin for chicken fillet shelf life extension. Int J Biol Macromol 160, 409-417 (2020).
132. Soni, B., Hassan, E. B., Schilling, M. W. & Mahmoud, B. Transparent bionanocomposite films based on chitosan and TEMPO-oxidized cellulose nanofibers with enhanced mechanical and barrier properties. Carbohydr Polym 151, 779-789 (2016).
133. Schnell, C. N. et al. Films from xylan/chitosan complexes: preparation and characterization. Cellulose 24, 4393-4403 (2017).
134. Nuruddin, M. et al. Gas and Water Vapor Barrier Performance of Cellulose Nanocrystal-Citric Acid-Coated Polypropylene for Flexible Packaging. ACS Applied Polymer Materials 2, 4405-4414 (2020).
135. Ghanbarzadeh, B., Almasi, H. & Entezami, A. A. Improving the barrier and mechanical properties of corn starch-based edible films: Effect of citric acid and carboxymethyl cellulose. Industrial Crops and Products 33, 229-235 (2011).
136. Chi, K. & Catchmark, J. M. in Green Polymer Chemistry: New Products, Processes, and Applications Vol. 1310 (eds H. N. Cheng, Richard A. Gross, & Patrick B. Smith) Ch. 8, (American Chemical Society, 2018).
137. Chi, K. & Catchmark, J. M. Improved eco-friendly barrier materials based on crystalline nanocellulose/chitosan/carboxymethyl cellulose polyelectrolyte complexes. Food Hydrocolloids 80, 195-205 (2018).
138. Chi, K., Wang, H. & Catchmark, J. M. Sustainable starch-based barrier coatings for packaging applications. Food Hydrocolloids 103 (2020).
139. Chi, K., He, J., Lin, W. S., Bokhari, S. M. Q. & Catchmark, J. M. Electrostatically Complexed Natural Polysaccharides as Aqueous Barrier Coatings for Sustainable and Recyclable Fiber-Based Packaging. ACS Appl Mater Interfaces 15, 12248-12260 (2023).
140. Wang, Q. & Schlenoff, J. B. The Polyelectrolyte Complex/Coacervate Continuum. Macromolecules 47, 3108-3116 (2014).
141. Kabanov, V. A. Polyelectrolyte complexes in solution and in bulk. Russian Chemical Reviews 74, 3-20 (2005).
142. Manoj Lalwani, S., Eneh, C. I. & Lutkenhaus, J. L. Emerging trends in the dynamics of polyelectrolyte complexes. Phys Chem Chem Phys 22, 24157-24177 (2020).
143. Fares, H. M., Wang, Q., Yang, M. & Schlenoff, J. B. Swelling and Inflation in Polyelectrolyte Complexes. Macromolecules 52, 610-619 (2019).
144. Shiratori, S. S. & Rubner, M. F. pH-Dependent Thickness Behavior of Sequentially Adsorbed Layers of Weak Polyelectrolytes. Macromolecules 33, 4213-4219 (2000).
145. Kim, S. J., Shin, S. R., Lee, K. B., Park, Y. D. & Kim, S. I. Synthesis and characteristics of polyelectrolyte complexes composed of chitosan and hyaluronic acid. Journal of Applied Polymer Science 91, 2908-2913 (2004).
146. Cárdenas, A., Argüelles-Monal, W., Goycoolea, F. M., Higuera-Ciapara, I. & Peniche, C. Diffusion Through Membranes of the Polyelectrolyte Complex of Chitosan and Alginate. Macromolecular Bioscience 3, 535-539 (2003).
147. Hasan, S., Boddu, V. M., Viswanath, D. S. & Ghosh, T. K. Chitin and Chitosan. 1 edn, (Springer Cham, 2022).
148. Zhang, Y. et al. Molecular Origin of the Glass Transition in Polyelectrolyte Assemblies. ACS Cent Sci 4, 638-644 (2018).
149. Suarez-Martinez, P. C., Batys, P., Sammalkorpi, M. & Lutkenhaus, J. L. Time-Temperature and Time-Water Superposition Principles Applied to Poly(allylamine)/Poly(acrylic acid) Complexes. Macromolecules 52, 3066-3074 (2019).
150. Yamashita, Y. & Endo, T. Deterioration behavior of cellulose acetate films in acidic or basic aqueous solutions. Journal of Applied Polymer Science 91, 3354-3361 (2004).
151. K. M. Vårum, M. H. Ottøy & O. Smidsrød. Acid hydrolysis of chitosans. Carbohydrate Polymers 46, 89-98 (2001).
152. Sikorski, D., Gzyra-Jagiela, K. & Draczynski, Z. The Kinetics of Chitosan Degradation in Organic Acid Solutions. Mar Drugs 19 (2021).
153. Lalwani, S. M., Batys, P., Sammalkorpi, M. & Lutkenhaus, J. L. Relaxation Times of Solid-like Polyelectrolyte Complexes of Varying pH and Water Content. Macromolecules 54, 7765-7776 (2021).
154. Batys, P., Zhang, Y., Lutkenhaus, J. L. & Sammalkorpi, M. Hydration and Temperature Response of Water Mobility in Poly(diallyldimethylammonium)-Poly(sodium 4-styrenesulfonate) Complexes. Macromolecules 51, 8268-8277 (2018).
155. Zhang, Y., Li, F., Valenzuela, L. D., Sammalkorpi, M. & Lutkenhaus, J. L. Effect of Water on the Thermal Transition Observed in Poly(allylamine hydrochloride)-Poly(acrylic acid) Complexes. Macromolecules 49, 7563-7570 (2016).
156. Li, J., van Ewijk, G., van Dijken, D. J., van der Gucht, J. & de Vos, W. M. Single-Step Application of Polyelectrolyte Complex Films as Oxygen Barrier Coatings. ACS Appl Mater Interfaces 13, 21844-21853 (2021).
157. Lange, J. & Wyser, Y. Recent innovations in barrier technologies for plastic packaging—a review. Packaging Technology and Science 16, 149-158 (2003).
158. Massey, L. K. Film Properties of Plastics and Elastomers. Second Edition edn, (William Andrew Publishing, 2004).
159. Steven, M. D. & Hotchkiss, J. H. Comparison of flat film to total package water vapour transmission rates for several commercial food wraps. Packaging Technology and Science 15, 17-27 (2002).
160. Ciriminna, R., Meneguzzo, F., Delisi, R. & Pagliaro, M. Citric acid: emerging applications of key biotechnology industrial product. Chem Cent J 11, 22 (2017).
161. Kim, M. H., Kim, C. S., Lee, H. W. & Kim, K. Temperature dependence of dissociation constants for formic acid and 2,6-dinitrophenol in aqueous solutions up to 175° C. Journal of the Chemical Society, Faraday Transactions 92, 4951-4956 (1996).
162. Wang, X.-x. et al. The comparison of pKa determination between carbonic acid and formic acid and its application to prediction of the hydration numbers. Chemical Physics Letters 460, 339-342 (2008).
163. Dutra, F. R., Silva, C. S. & Custodio, R. On the Accuracy of the Direct Method to Calculate pK(a) from Electronic Structure Calculations. J Phys Chem A 125, 65-73 (2021).
164. Zhivkov, A. M. in Cellulose: Fundamental Aspects (eds Theo van de Ven & Louis Godbout) Ch. 8, (2013).
165. Samuelsen, L., Holm, R., Lathuile, A. & Schonbeck, C. Buffer solutions in drug formulation and processing: How pK(a) values depend on temperature, pressure and ionic strength. Int J Pharm 560, 357-364 (2019).
166. Wang, Q. Z. et al. Protonation constants of chitosan with different molecular weight and degree of deacetylation. Carbohydrate Polymers 65, 194-201 (2006).
167. Jha, P. Effect of plasticizer and antimicrobial agents on functional properties of bionanocomposite films based on corn starch-chitosan for food packaging applications. Int J Biol Macromol 160, 571-582 (2020).
168. Pal, N., Banerjee, S., Roy, P. & Pal, K. Reduced graphene oxide and PEG-grafted TEMPO-oxidized cellulose nanocrystal reinforced poly-lactic acid nanocomposite film for biomedical application. Mater Sci Eng C Mater Biol Appl 104, 109956 (2019).
169. Youssef, A. M., El-Sayed, S. M., El-Sayed, H. S., Salama, H. H. & Dufresne, A. Enhancement of Egyptian soft white cheese shelf life using a novel chitosan/carboxymethyl cellulose/zinc oxide bionanocomposite film. Carbohydr Polym 151, 9-19 (2016).
170. K., S. S., P., I. M. & R., R. G. Mahua oil-based polyurethane/chitosan/nano ZnO composite films for biodegradable food packaging applications. Int J Biol Macromol 124, 163-174 (2019).
171. Elfeky, A. S. et al. Multifunctional cellulose nanocrystal/metal oxide hybrid, photo-degradation, antibacterial and larvicidal activities. Carbohydr Polym 230, 115711 (2020).
172. John, A., Ko, H.-U., Kim, D.-G. & Kim, J. Preparation of cellulose-ZnO hybrid films by a wet chemical method and their characterization. Cellulose 18, 675-680 (2011).
173. Zare, M. et al. Smart Fortified PHBV-CS Biopolymer with ZnO—Ag Nanocomposites for Enhanced Shelf Life of Food Packaging. ACS Appl Mater Interfaces 11, 48309-48320 (2019).
174. Khodayari, M. et al. Effect of poly(lactic acid) films incorporated with different concentrations of Tanacetum balsamita essential oil, propolis ethanolic extract and cellulose nanocrystals on shelf life extension of vacuum-packed cooked sausages. Food Packaging and Shelf Life 19, 200-209 (2019).
175. Coma, V., Sebti, I., Pardon, P., Pichavant, F. H. & Deschamps, A. Film properties from crosslinking of cellulosic derivatives with a polyfunctional carboxylic acid. Carbohydrate Polymers 51, 265-271 (2003).
176. Ertan, K., Sahin, S. & Sumnu, G. Gallic acid crosslinked peanut protein-corn starch composite edible films produced at alkaline pH with ultrasound application. Journal of Applied Polymer Science 141 (2024).
177. Chen, C., Sun, W., Wang, J. & Gardner, D. J. Tunable biocomposite films fabricated using cellulose nanocrystals and additives for food packaging. Carbohydr Polym 321, 121315 (2023).
178. Haghighi, H. et al. Development of antimicrobial films based on chitosan-polyvinyl alcohol blend enriched with ethyl lauroyl arginate (LAE) for food packaging applications. Food Hydrocolloids 100 (2020).
179. Cazón, P., Velazquez, G. & Vázquez, M. Novel composite films from regenerated cellulose-glycerol-polyvinyl alcohol: Mechanical and barrier properties. Food Hydrocolloids 89, 481-491 (2019).
180. Strang, A. et al. Simple and Versatile Platforms for Manipulating Light with Matter: Strong Light-Matter Coupling in Fully Solution-Processed Optical Microcavities. Adv Mater, e2212056 (2023).
181. Kakihana, M., Kobayashi, M., Tomita, K. & Petrykin, V. Application of Water-Soluble Titanium Complexes as Precursors for Synthesis of Titanium-Containing Oxides via Aqueous Solution Processes. Bulletin of the Chemical Society of Japan 83, 1285-1308 (2010).
182. Cohen-Arazi, N., Katzhendler, J., Kolitz, M. & Domb, A. J. Preparation of New α-Hydroxy Acids Derived from Amino Acids and Their Corresponding Polyesters. Macromolecules 41 (2008).
183. Tang, R., Yu, Z., Renneckar, S. & Zhang, Y. Coupling chitosan and TEMPO-oxidized nanofibrilliated cellulose by electrostatic attraction and chemical reaction. Carbohydr Polym 202, 84-90 (2018).
184. Lai, C., Zhang, S., Chen, X. & Sheng, L. Nanocomposite films based on TEMPO-mediated oxidized bacterial cellulose and chitosan. Cellulose 21, 2757-2772 (2014).
185. El Miri, N. et al. Bio-nanocomposite films based on cellulose nanocrystals filled polyvinyl alcohol/chitosan polymer blend. Journal of Applied Polymer Science 132, n/a-n/a (2015).
186. Salama, H. E. & Abdel Aziz, M. S. Optimized carboxymethyl cellulose and guanidinylated chitosan enriched with titanium oxide nanoparticles of improved UV-barrier properties for the active packaging of green bell pepper. Int J Biol Macromol 165, 1187-1197 (2020).
187. Noshirvani, N. et al. Cinnamon and ginger essential oils to improve antifungal, physical and mechanical properties of chitosan-carboxymethyl cellulose films. Food Hydrocolloids 70, 36-45 (2017).
188. Valizadeh, S., Naseri, M., Babaei, S., Hosseini, S. M. H. & Imani, A. Development of bioactive composite films from chitosan and carboxymethyl cellulose using glutaraldehyde, cinnamon essential oil and oleic acid. Int J Biol Macromol 134, 604-612 (2019).
189. Shilova, S. V., Mirgaleev, G. M., Tret′yakova, A. Y. & Barabanov, V. P. Polyelectrolyte Complexes of Chitosan with Sodium Carboxymethyl Cellulose in Water-Alcohol Media and Microcapsules Based on Them. Polymer Science, Series A 62, 630-635 (2020).
190. Ferreira, D. C. M. et al. Polyelectrolyte complexes (PECs) obtained from chitosan and carboxymethylcellulose: A physicochemical and microstructural study. Carbohydrate Polymer Technologies and Applications 3 (2022).
191. Blagodatskikh, I. V. et al. Complexation between chitosan and carboxymethyl cellulose in weakly acidic, neutral, and weakly alcaline media. Int J Biol Macromol 243, 125277 (2023).
192. Ravanat, G. & Rinaudo, M. Investigation on oligo- and polygalacturonic acids by potentiometry and circular dichroism. Biopolymers 19, 2209-2222 (2004).
193. Alginates: Biology and Applications. Vol. 13 (Springer).
194. Haug, A., Myklestad, S., Larsen, B. & Smidsrød, O. Correlation between Chemical Structure and Physical Properties of Alginates. Acta Chemica Scandinavica 21 (1967).
195. Sogias, I. A., Khutoryanskiy, V. V. & Williams, A. C. Exploring the Factors Affecting the Solubility of Chitosan in Water. Macromolecular Chemistry and Physics 211, 426-433 (2010).
196. Cho, Y.-W., Jang, J., Park, C. R. & Ko, S.-W. Preparation and Solubility in Acid and Water of Partially Deacetylated Chitins. Biomacromolecules 1 (2000).
197. Wang, C. H. et al. Non-toxic O-quaternized chitosan materials with better water solubility and antimicrobial function. Int J Biol Macromol 84, 418-427 (2016).
198. Fan, Y., Saito, T. & Isogai, A. Chitin Nanocrystals Prepared by TEMPO-Mediated Oxidation of α-Chitin. Biomacromolecules 9, 192-198 (2008).
199. Song, Q., Zhang, Z., Gao, J. & Ding, C. Synthesis and property studies of N-carboxymethyl chitosan. Journal of Applied Polymer Science 119, 3282-3285 (2010).
200. Ifuku, S., Hori, T., Izawa, H., Morimoto, M. & Saimoto, H. Preparation of zwitterionically charged nanocrystals by surface TEMPO-mediated oxidation and partial deacetylation of alpha-chitin. Carbohydr Polym 122, 1-4 (2015).
201. Priftis, D., Megley, K., Laugel, N. & Tirrell, M. Complex coacervation of poly(ethylene-imine)/polypeptide aqueous solutions: thermodynamic and rheological characterization. J Colloid Interface Sci 398, 39-50 (2013).
202. Blandamer, M. J., Cullis, P. M. & Engberts, J. B. F. N. Titration microcalorimetry. Journal of the Chemical Society, Faraday Transactions 94, 2261-2267 (1998).
203. Fu, J. & Schlenoff, J. B. Driving Forces for Oppositely Charged Polyion Association in Aqueous Solutions: Enthalpic, Entropic, but Not Electrostatic. J Am Chem Soc 138, 980-990 (2016).
204. Archer, W. R. & Schulz, M. D. Isothermal titration calorimetry: practical approaches and current applications in soft matter. Soft Matter 16, 8760-8774 (2020).
205. Fu, J., Fares, H. M. & Schlenoff, J. B. Ion-Pairing Strength in Polyelectrolyte Complexes. Macromolecules 50, 1066-1074 (2017).
206. Prado, H. J. & Matulewicz, M. C. Cationization of polysaccharides: A path to greener derivatives with many industrial applications. European Polymer Journal 52, 53-75 (2014).
207. Bizley, S. C., Williams, A. C. & Khutoryanskiy, V. V. Thermodynamic and kinetic properties of interpolymer complexes assessed by isothermal titration calorimetry and surface plasmon resonance. Soft Matter 10, 8254-8260 (2014).
208. Liu, W., Sun, F., Jiang, L., Meredith, J. C. & Deng, Y. Surface Structure Patterning for Fabricating Non-fluorinated Superhydrophobic Cellulosic Membranes. ACS Applied Polymer Materials 1, 1220-1229 (2019).
209. Brown, A. et al. Superhydrophobic Functionalization of Cotton Fabric via Reactive Dye Chemistry and a Thiol-ene Click Reaction. Industrial & Engineering Chemistry Research 58, 22534-22540 (2019).
210. Musikavanhu, B. et al. Facile method for the preparation of superhydrophobic cellulosic paper. Applied Surface Science 496 (2019).
211. Che, X. M., Wei, D. X. & Chen, G. Q. Superhydrophobic Polyhydroxyalkanoates: Preparation and Applications. Biomacromolecules 20, 618-624 (2019).
212. Sun, X. et al. Super-hydrophobic poly (lactic acid) by controlling the hierarchical structure and polymorphic transformation. Chemical Engineering Journal 397 (2020).
213. Cao, Z. et al. Ductile and biodegradable poly (lactic acid) matrix film with layered structure. Int J Biol Macromol 137, 1141-1152 (2019).
214. Zhao, K., Deng, Y., Chen, J. C. & Chen, G.-Q. Polyhydroxyalkanoate (PHA) scaffolds with good mechanical properties and biocompatibility. Biomaterials 24, 1041-1045 (2003).
215. Benhabiles, M. S. et al. Antibacterial activity of chitin, chitosan and its oligomers prepared from shrimp shell waste. Food Hydrocolloids 29, 48-56 (2012).
216. Haqiqi, M. T. et al. Antioxidant and UV-Blocking Properties of a Carboxymethyl Cellulose-Lignin Composite Film Produced from Oil Palm Empty Fruit Bunch. ACS Omega 6, 9653-9666 (2021).
217. Song, Y., Chen, S., Chen, Y., Xu, Y. & Xu, F. Biodegradable and transparent films with tunable UV-blocking property from Lignocellulosic waste by a top-down approach. Cellulose 28, 8629-8640 (2021).
218. Bejagam, K. K., Iverson, C. N., Marrone, B. L. & Pilania, G. Composition and Configuration Dependence of Glass-Transition Temperature in Binary Copolymers and Blends of Polyhydroxyalkanoate Biopolymers. Macromolecules 54, 5618-5628 (2021).
219. Dilkes-Hoffman, L. S., Pratt, S., Lant, P. A., Levett, I. & Laycock, B. Polyhydroxyalkanoate coatings restrict moisture uptake and associated loss of barrier properties of thermoplastic starch films. Journal of Applied Polymer Science 135 (2018).
220. Li, Z., Yang, J. & Loh, X. J. Polyhydroxyalkanoates: opening doors for a sustainable future. NPG Asia Materials 8, e265-e265 (2016).
221. Shin, S. H., Kim, S. J., Lee, S. H., Park, K. M. & Han, J. Apple peel and carboxymethylcellulose-based nanocomposite films containing different nanoclays. J Food Sci 79, E342-353 (2014).
222. Gontard, N., Thibault, R., Cuq, B. & Guilbert, S. Influence of relative humidity and film composition on oxygen and carbon dioxide permeabilities of edible films. J. Agric. Food Chem. 44, 1064-1069 (1996).
223. Nyflött, Å. et al. The influence of moisture content on the polymer structure of polyvinyl alcohol in dispersion barrier coatings and its effect on the mass transport of oxygen. Journal of Coatings Technology and Research 14, 1345-1355 (2017).
224. Duner, G., Thormann, E. & Dedinaite, A. Quartz Crystal Microbalance with Dissipation (QCM-D) studies of the viscoelastic response from a continuously growing grafted polyelectrolyte layer. J Colloid Interface Sci 408, 229-234 (2013).
225. Apelblat, A. Citric Acid. (Springer, 2014).
226. Hyde, A. M. et al. General Principles and Strategies for Salting-Out Informed by the Hofmeister Series. Organic Process Research & Development 21, 1355-1370 (2017).
227. Zhang, P., Alsaifi, N. M., Wu, J. & Wang, Z.-G. Salting-Out and Salting-In of Polyelectrolyte Solutions: A Liquid-State Theory Study. Macromolecules 49, 9720-9730 (2016).

The references cited herein are hereby incorporated by reference to disclose and describe the methods or materials in connection with which the publications are cited or to provide background for the present disclosure. Any incorporation by reference of documents herein is limited such that no subject matter is incorporated by reference that is contrary to the explicit disclosure herein. In the event of inconsistent usages between this document and those documents so incorporated by reference herein, the use in the incorporated references should be considered supplementary to that of this document; for irreconcilable inconsistencies, the usage in this document controls.

The compositions and methods of the appended claims are not limited in scope by the specific compositions and methods described herein, which are intended as illustrations of a few aspects of the claims, and any compositions and methods that are functionally equivalent are intended to fall within the scope of the claims. Various modifications of the compositions and methods. in addition to those shown and described herein, are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

What is claimed is:

1. An article comprising a composition,
wherein the composition comprises a polyelectrolyte complex,
wherein the polyelectrolyte complex is formed from a cellulose derivative and chitosan.

2. The article of claim 1, wherein the article is a film, a coating, a tape, a foam, a bulk material, or a packaging material.

3. The article of claim 1, wherein the article is a film.

4. The article of claim 1, wherein the cellulose derivative comprises carboxymethyl cellulose (CMC).

5. The article of claim 4, wherein carboxymethyl cellulose has a degree of substitution of about 1.2.

6. The article of claim 1, wherein the chitosan comprises from about 50% to about 75% by weight based on a total weight of the composition.

7. The article of claim 1, wherein the chitosan has a degree of ionization from about 20% to about 40%.

8. The article of claim 1, wherein the composition is further crosslinked with a crosslinker.

9. The article of claim 8, wherein the crosslinker comprises citric acid (CA).

10. The article of claim 9, wherein the crosslinker comprises citric acid in an amount of about 25% by weight based on a total weight of the composition.

11. The article of claim 10, wherein at a temperature of about 23° C. and a relative humidity from about 50% to about 75%, the composition has a thickness-adjusted water vapor transmission rate (WVTR) from about 0.014 to about 4 g-mm/m²-day.

12. The article of claim 10, wherein the composition has a residual water content (RWC) from about 4% to about 6%.

13. A process of manufacturing a film of claim 3, the process comprising:
preparing a first solution comprising the cellulose derivative and a volatile acid, wherein the volatile acid is present in the first solution in an amount to adjust the pH of the first solution from about 1 to about 2;
preparing a second solution comprising the chitosan and the volatile acid, wherein the volatile acid is present in the second solution in an amount to adjust the pH of the second solution from about 1 to about 2;
combining the first solution and the second solution to form a mixture; and
casting and drying the mixture to form the film.

14. The process of claim 13, wherein the volatile acid comprises formic acid.

15. The process of claim 13, wherein the first solution, the second solution, or both, further includes a crosslinker.

16. An article comprising a composition,
wherein the composition comprises:
cellulose or a cellulose derivative; and
citric acid (CA);
wherein the cellulose or cellulose derivative is crosslinked with the citric acid; and
wherein the citric acid is present in an amount of about 25% by weight based on a total weight of the composition.

17. The article of claim 16, wherein the article is a film, a coating, a tape, a foam, a bulk material, or a packaging material.

18. The article of claim 16, wherein the article is a film.

19. The article of claim 16, wherein the cellulose derivative comprises carboxymethyl cellulose (CMC).

20. The article of claim 16, wherein, at a temperature of about 23° C. and a relative humidity up to about 65%, the composition has a thickness-adjusted water vapor transmission rate (WVTR) of less than about 0.02 g-mm/m²-day.
